(19) United States
(12) Patent Application Publication
(10) Pub. No.: US 2026/0146162 A1
(43) Pub. Date: May 28, 2026

(54) PROCESS FOR PROVIDING LOW GLOSS COATINGS

(71) Applicant: Covestro (Netherlands) B.V., Geleen (NL)

(72) Inventors: Ronald TENNEBROEK, Dongen (NL); Ilse VAN CASTEREN, Veldhoven (NL); Johan Franz Gradus Antonius JANSEN, Geleen (NL); Michael VILLET, Maastricht (NL)

(21) Appl. No.: 19/103,408

(22) PCT Filed: Aug. 22, 2023
(86) PCT No.: PCT/EP2023/073039

§ 371 Date: Feb. 12, 2025

(30) Foreign Application Priority Data
Aug. 24, 2022 (EP) 22191845.1
Aug. 24, 2022 (EP) 22191847.7
Aug. 24, 2022 (EP) 22191849.3
Aug. 24, 2022 (EP) 22191850.1

(51) Int. Cl. C09D 4/06; C09D 175/12

(52) U.S. Cl. CPC C09D 4/06; C09D 175/12

(57) ABSTRACT

The present invention relates to a process for producing a coating from an aqueous, radiation-curable coating composition, wherein the process comprises the steps in the sequence (1) to (4):
(1) applying an aqueous, radiation-curable coating composition on a surface of a substrate,
(2) drying the aqueous, radiation-curable coating composition, affording an at least partially dried coating composition,
(3) irradiating the at least partially dried coating composition with UV light having a wavelength ≤220 nm under inert atmosphere, followed by
(4) irradiating with UV light having a wavelength ≥300 nm or with E-beam,
   wherein the aqueous, radiation-curable coating composition is a dispersion comprising:
(A) at least one hybrid (A) of at least one polyurethane and at least one vinyl polymer, wherein
the hybrid (A) is obtained by free-radical polymerization of at least one vinyl monomer in the presence of at least one water-dispersed polyurethane,
the hybrid (A) is essentially free of radiation-curable, ethylenically unsaturated bonds,
the polyurethane of the hybrid (A) has a urea group (—NH—CO—NH—) concentration of at least 0.1 milli-equivalents per g of polyurethane and of at most 1.9 milli-equivalents per g of polyurethane, and
the polyurethane and the vinyl polymer of the hybrid (A) are present in a weight ratio of polyurethane and vinyl polymer ranging from 25:75 to 95:5,
(B) at least one radiation-curable diluent (B) with a molar mass less than 750 g/mol and with an acrylate functionality of from 2 to 5, and
(C) water and optionally organic solvent, whereby the optional organic solvent is present in an amount of at most 30 wt. %, based on the total amount of water and organic solvent, wherein
the amount of (A) is from 30 to 85 wt. % and the amount of (B) is from 15 to 70 wt. %, based on the total amount of (A) and (B).

The present invention relates to the field of aqueous radiation-curable polyurethane-vinyl polymer hybrid coating compositions having a low gloss. The present invention also relates to a process for producing a low gloss coating from an aqueous radiation-curable coating composition.

Aqueous radiation-curable polyurethane-vinyl polymer hybrid dispersions are widely used to produce materials such as coatings, inks and/or adhesives. After applying the aqueous radiation-curable polyurethane-vinyl polymer hybrid dispersion on the substrate, the dispersion is dried affording an at least partially dried coating composition, and the at least partially dried coating composition is subsequently irradiated with UV light having a wavelength ≥300 nm or with E-beam, thereby obtaining a radiation cured coating. Such radiation cured coatings exhibit very good properties on numerous substrates like wood, plastic, concrete, metal, glass and/or textiles. The structure and functionality of the radiation-curable polyurethane-vinyl polymer hybrid coating composition is known to govern factors such as the speed of cure, the extent of crosslinking and the final properties of the coating (especially properties such as flexibility, hardness, adhesion, scratch resistance and/or chemical resistance).

“Low gloss” surfaces give products a much sought-after aesthetic effect, especially in the wood-furniture, flooring and wall covering industry, because they can create a very natural appearance that contribute to giving greater emphasis to the materiality of the article. At present, the creation of matte surfaces frequently involves the use of coating products the formulation of which contains matting agents made from organic and/or inorganic substances which, by positioning themselves on the coated surface and/or emerging on it, are able to act on the degree of reflection of light, giving the observer the visual sensation of a low gloss surface. However, the use of matting agents produces a worsening of the surface performance of the coating since, not being involved in the crosslinking and polymerization process, they lead to a significant reduction of stain resistance. Further there is a tendency for the matting agent to migrate to the coating surface after application and consequently the matting agent might get lost upon mechanical deformation, caused by for example scratch, resulting in an increase of gloss.

The resistance to typical household chemicals, such as coffee, red wine and mustard, is also strongly reduced by the use of matting agents. Long-term action of these household chemicals leads at least to a reduction in quality of the coating and possibly even to its complete destruction. Silica based compounds are the majorly used matting agents. In general silica based matting agents are porous illustrated by its oil absorption values ranging from 100-500 mL/100 gr. The disadvantage of using this type of matting agent in coating formulations is that it not only deteriorates the quality of the final coating, but can also result in an undesired coloration of the exposed coating area, because especially colored household stains like coffee, red wine and mustard (part of DIN 1B) are easily absorbed by the porous silica and because these stains contain organic dyes, this can result in a undesired coloring of the exposed coating area.

The object of the present invention is to provide a method for obtaining a low gloss coating from an aqueous radiation-curable polyurethane-vinyl polymer hybrid dispersion without having to use matting agent.

According to the invention there is provided a process for producing a coating from an aqueous, radiation-curable coating composition, wherein the process comprises the steps in the sequence (1) to (4):
(1) applying an aqueous, radiation-curable coating composition on a surface of a substrate,
(2) drying the aqueous, radiation-curable coating composition, affording an at least partially dried coating composition,
(3) irradiating the at least partially dried coating composition with UV light having a wavelength ≤220 nm under inert atmosphere, followed by
(4) irradiating with UV light having a wavelength >300 nm or with E-beam, wherein the aqueous, radiation-curable coating composition is a dispersion comprising:
   (A) at least one hybrid (A) of at least one polyurethane and at least one vinyl polymer, wherein
      the hybrid (A) is obtained by free-radical polymerization of at least one vinyl monomer in the presence of at least one water-dispersed polyurethane,
      the hybrid (A) is essentially free of radiation-curable, ethylenically unsaturated bonds,
      the polyurethane of the hybrid (A) has a urea group (—NH—CO—NH—) concentration of at least 0.1 milli-equivalents per g of polyurethane and of at most 1.9 milli-equivalents per g of polyurethane, and
      the polyurethane and the vinyl polymer of the hybrid (A) are present in a weight ratio of polyurethane and vinyl polymer ranging from 25:75 to 95:5,
   (B) at least one radiation-curable diluent (B) with a molar mass less than 750 g/mol and with an acrylate functionality of from 2 to 5, and
   (C) water and optionally organic solvent, whereby the optional organic solvent is present in an amount of at most 30 wt. % (weight percent), based on the total amount of water and organic solvent,
wherein
the amount of (A) is from 30 to 85 wt. % and the amount of (B) is from 15 to 70 wt. %, based on the total amount of (A) and (B).

It has surprisingly been found that, without the use of matting agent, the method of the present invention, which method includes the pre-treatment of the coating composition with UV light with a wavelength ≤220 nm (further also referred to as the excimer radiation step), makes it possible to obtain low gloss coatings from aqueous, radiation-curable polyurethane-vinyl polymer hybrid dispersions as defined herein and this while the water-dispersed polyurethane-vinyl polymer hybrid is essentially free of radiation-curable, ethylenically unsaturated bonds. More in particular with the process of the invention a coating can be obtained with a gloss measured at 20° geometry of angle lower than 10 gloss units and preferably with a gloss measured at 60° geometry of angle lower than 40 gloss units (further referred to as low gloss), more preferably with a gloss measured at 60° geometry of angle lower than 30 gloss units, more preferably lower than 20 gloss units, even more preferably lower than 10 gloss units and even more preferably lower than 5 gloss units. The aqueous, radiation-curable coating composition according to the invention allows to obtain a difference in gloss measured at 60° geometry of angle with and without the excimer radiation step of at least 40 gloss units, preferably of at least 50 gloss units, more preferably of at least 60 gloss units. It has furthermore surprisingly been found that the method of the present invention makes it possible to obtain low gloss coatings from aqueous, radiation-curable polyurethane-vinyl polymer hybrid dispersions as defined herein, without the use of matting agents, while improving the coffee, red wine and/or mustard resistance of the coating compared to when the dispersions contain matting agent. It has furthermore surprisingly been found that, without the use of matting agent, the method of the present invention makes it possible to obtain low gloss coatings from aqueous, radiation-curable polyurethane-vinyl polymer hybrid dispersions as defined herein, with improved coffee, red wine and/or mustard resistance compared to when the coating is obtained without the excimer radiation step and this while the water-dispersed polyurethane-vinyl polymer hybrid is essentially free of radiation-curable, ethylenically unsaturated bonds.

An additional advantage of the present invention is that handling of matting agents is not required, which is advantageous since matting agents have a large surface area and contain a large proportion of dust-forming small particles that may create exposure and explosion hazards. An additional advantage of not having to use matting agents for obtaining low gloss coatings is that coating compositions with less or no settling and thus improved storage stability can be achieved. An additional advantage of the method of the present invention is that coatings with a significantly higher smoothness can be obtained compared to when the coatings contained matting particles.

WO-A-2013/092521 describes a process for the production of homogeneous matted coatings on flat surfaces based on a so-called 100% radiation-curable coating compositions. In this method, first, the 100% radiation-curable coating composition, that contains a low molecular weight, radiation-curable oligomer as binder and optionally one or more reactive thinners to reduce the viscosity, is coated on the surface of a flat substrate with a spiral blade. This wet paint layer is subsequently irradiated with UV light with a wavelength of from 200 to 420 nm and a radiation dose of 25 to 120 mJ/cm² resulting in partial gelation of the coating composition. Then the so-obtained coating is irradiated with UV light from an Excimer lamp having a wavelength from 120 nm to 230 nm under inert gas, followed by finish curing using conventional UV emitters. A 100% radiation-curable coating composition refers to a coating composition having a solids content of 100 wt. %. 100% radiation-curable coating compositions are homogeneous systems having only one phase, while the aqueous, radiation-curable polyurethane-vinyl polymer hybrid coating compositions as defined herein are dispersions having at least two phases where one phase contains discrete particles (colloidally dispersed particles) distributed throughout an aqueous medium, the particles being the dispersed phase and the aqueous medium the continuous phase.

WO-A-2013/092521 does not teach that low gloss coatings could be obtained from aqueous coating compositions, let alone from aqueous, radiation-curable polyurethane-vinyl polymer hybrid dispersions as defined herein and is furthermore silent on stain resistances of the cured coating.

A further disadvantage of the method described in WO-A-2013/092521 is that the viscosity of 100% radiation-curable coating composition is usually high making some application techniques, such as spraying, for example, difficult or impossible to use to apply the coating composition to the substrate. Spraying applications can advantageously be used to apply coating composition on substrates with more complex shapes, such as for example furniture or decorative frames. The viscosity of 100% radiation-curable coating composition can be reduced by adding monofunctional diluents with low molecular weight, resulting in that a viscosity can be obtained that allows depositing the radiation-curable coating composition on a substrate by spraying. However, applying of 100% radiation-curable coating composition by spraying inherently results in a coating with high coating thickness.

An additional advantage of the use of aqueous, radiation-curable polyurethane-vinyl polymer hybrid dispersions as defined herein is that the viscosity can be steered by adjusting the solids with water, resulting in that with the process of the invention coatings can also easily be applied by spraying even in a low coating thickness such as for example 25 micron wet coating thickness.

An additional advantage of the fact that the aqueous, radiation-curable polyurethane-vinyl polymer hybrid dispersions as defined herein are more easily spray-applied is that the method of the invention also makes it possible to obtain low gloss coatings on more complex shaped articles such as, for example, a decorative frame with a more uniform degree of gloss of the coated article.

An additional advantage of the use of aqueous, radiation-curable coating composition as defined herein is that coatings with a lower thickness, such as for example a coating thickness of 50 micron or even less, can be rendered low gloss using the method of the invention. A further advantage of the invention is that the gloss level of the coating can be tuned with the residual water and/or organic solvent content that is present in the at least partially dried coating composition.

It has furthermore surprisingly been found that that with the coating composition as claimed a low gloss coating can be obtained in only 2 irradiation steps (i.e. step (3) and (4), in particular for coatings with a wet thickness (before drying) of at most 300 micron, or at most 250 micron, or at most 200 micron or at most 175 micron, in particular of at most 150 micron, more in particular of at most 125 micron, more in particular of at most 100 micron and more in particular of at most 75 micron. WO-A-2013/092521 teaches that an additional partial gelation irradiation step is needed prior to the excimer radiation step (step (3) of the process of the present invention) and the finish curing step (step (4) of the process of the present invention) and thus WO-A-2013/092521 teaches that three irradiation steps are needed to obtain a low gloss/matte coating with a homogeneous surface structure, see in particular Table 2.

The aqueous, radiation-curable coating composition used in the process of the invention comprises polyurethane-vinyl polymer hybrid in dispersed form, i.e. the composition comprises dispersed particles of the polyurethane-vinyl polymer hybrid.

A dispersion refers to a system with at least two phases where one phase contains discrete particles (colloidally dispersed particles) distributed throughout a bulk substance, the particles being the disperse phase and the bulk substance the continuous phase. The continuous phase of an aqueous dispersion is provided at least in part by water. Preferably the continuous phase of the dispersion of the invention comprises at least 75 wt. %, more preferably at least 80 wt. %, even more preferably at least 90 wt. % of water (relative to the continuous phase).

The aqueous coating composition used in the process of the invention is radiation-curable.

By radiation-curable is meant that radiation is required to initiate crosslinking of the dispersion. The aqueous coating composition used in the process of the invention contains ethylenically unsaturated (C═C) bond functionality which under the influence of irradiation, preferably in combination with the presence of a (photo) initiator, can undergo crosslinking by free radical polymerisation.

As used herein, the acrylate functionality of a compound is the number of acrylate functional groups per molecule of the compound.

An acrylate functional group has the following formula:

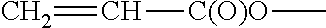

For all upper and/or lower boundaries of any range given herein, the boundary value is included in the range given, unless specifically indicated otherwise. Thus, when saying from x to y, means including x and y and also all intermediate values.

As used herein, the acid value of a polymer, such as the acid values of the polyurethane, the vinyl polymer and of the polyurethane-vinyl polymer hybrid (A), is the theoretical acid value and is determined according to the following formula:

$$AV polymer [ mg KOH / g solids polymer ] = ( sum of acid groups present in the polymer ( in moles ) / total weight polymer ) * 56.1 * 1000.$$

### Polyurethane-Vinyl Polymer Hybrid (A)

The at least one hybrid (A) of at least one polyurethane and at least one vinyl polymer is obtained by free-radical polymerization of one or more vinyl monomers in the presence of at least one water-dispersed polyurethane as described herein below.

The radiation-curable diluent (B) is added after having carried out the free-radical polymerization of vinyl monomer(s) to obtain the vinyl polymer of the polyurethane-vinyl polymer hybrid. The polyurethane is preferably prepared in the presence of at least part of the one or more vinyl monomers used to prepare the vinyl polymer.

The vinyl polymer is advantageously formed in-situ by polymerizing the one or more vinyl monomers in the presence of a preformed aqueous polyurethane dispersion.

By a polyurethane-vinyl polymer hybrid is meant that a vinyl polymer is prepared by the free-radical polymerization of vinyl monomer(s) in the presence of the polyurethane by forming an aqueous dispersion of said polyurethane resin and polymerising one or more vinyl monomers to form a vinyl polymer such that said vinyl polymer becomes incorporated in-situ into said aqueous dispersion by virtue of polymerising vinyl monomer(s) used to form the vinyl polymer in the presence of the polyurethane resin. Vinyl monomer is added before, during and/or after preparation of the polyurethane and the vinyl monomer is polymerized by adding a free radical initiator to polymerize the vinyl monomer in the presence of the polyurethane.

The weight ratio of the polyurethane to vinyl polymer present in the polyurethane-vinyl polymer hybrid (A) is in the range of from 25:75 to 95:5, preferably from 30:70 to 90:10, more preferably from 40:60 to 88:12, more preferably from 50:50 to 85:15, more preferably from 65:35 to 80:20.

The theoretical acid value of the polyurethane-vinyl polymer hybrid (A) is preferably within the range of from 3 to 45 mg KOH/g of the hybrid (A), preferably from 4 to 40 mg KOH/g of the hybrid (A), more preferably from 5 to 35 mg KOH/g of the hybrid (A), more preferably from 6 to 28 mg KOH/g of the hybrid (A).

### Polyurethane

The urea group (—NH—CO—NH—) concentration of the polyurethane is at least 0.1 and at most 1.9 milli-equivalents per g of polyurethane. It has surprisingly been found that using polyurethane with a urea bond concentration of higher than 1.9 milli-equivalents per g of polyurethane in the process comprising the steps (1) to (4) does not result in low gloss coatings. The polyurethane preferably has a urea group content of at most 1.7 milli-equivalents (meq) per g of polyurethane, more preferably of at most 1.5 meq per g of polyurethane, even more preferably of at most 1.3 meq per g of (A), even more preferably of at most 1.1 meq per g of polyurethane, even more preferably of at most 0.9 meq per g of polyurethane and preferably of at least 0.2 meq per g of polyurethane, more preferably of at least 0.3 meq per g of polyurethane, more preferably of at least 0.35 meq per g of polyurethane, even more preferably of at least 0.4 meq per g of polyurethane. The urea group (—NH—CO—NH—) concentration of the polyurethane is determined by calculation as further described herein.

Methods for preparing polyurethanes are known in the art and are described in for example the Polyurethane Handbook 2^{nd} Edition, a Carl Hanser publication, 1994, by G. Oertel. Usually an isocyanate-terminated polyurethane prepolymer is first formed which is then preferably chain extended with a nitrogen containing compound.

The polyurethane is preferably prepared from the reaction of at least the following components, more preferably the polyurethane (A) is prepared from the reaction of the following components:
(A1) At least one polyisocyanate,
(A2) At least one isocyanate-reactive compound that contains at least one salt group which is capable to render the polyurethane dispersible in water and/or a functional group that can be converted into a salt group which is capable to render the polyurethane dispersible in water, preferably acid functional,
(A3) Optionally at least one isocyanate-reactive compound containing at least one non-ionic group which is capable to render the polyurethane dispersible in water,
(A4) At least one isocyanate-reactive polyol other than (A2) and (A3) having an OH number of from 25 to 225 mg KOH/g solids,
(A5) Optionally at least one isocyanate-reactive polyol other than (A2) and (A3) having an OH number higher than 225 mg KOH/g solids and lower than 1850 mg KOH/g solids, and
(A6) Water and/or at least one nitrogen containing chain extender compound.

A preferred isocyanate-reactive group is a hydroxyl group.

### Component (A1)

At least one polyisocyanate is used as component (A1). The at least one polyisocyanate which is used according to the present invention is preferably selected from the group consisting of diisocyanates having the general formula Y(NCO)2, where Y is a C4-12 divalent aliphatic hydrocarbon group, i.e. an aliphatic diisocyanate compound, a C6-15 divalent alicyclic hydrocarbon group, i.e. an alicyclic diisocyanate compound, a C6-15 divalent aromatic hydrocarbon group, i.e. an aromatic diisocyanate compound, or a C7-15 divalent araliphatic hydrocarbon group, i.e. an araliphatic diisocyanate compound. Examples of suitable organic difunctional isocyanates (component (A1)) include ethylene diisocyanate, 1,5-pentamethylenediisocyanate (PDI), 1,6-hexamethylene diisocyanate (HDI), isophorone diisocyanate (IPDI), cyclohexane-1,4-diisocyanate, dicyclohexylmethane diisocyanate (HMDI) such as 4,4′-dicyclohexylmethane diisocyanate (4,4′-H₁₂ MDI), p-xylylene diisocyanate, p-tetramethylxylene diisocyanate (p-TMXDI) (and its meta isomer m-TMXDI), 1,4-phenylene diisocyanate, 2,4-toluene diisocyanate, 2,6-toluene diisocyanate, hydrogenated 2,4-toluene diisocyanate, hydrogenated 2,6-toluene diisocyanate, 4,4′-diphenylmethane diisocyanate (4,4′-MDI), 2,4′-diphenylmethane diisocyanate, 3 (4)-isocyanatomethyl-1-methyl cyclohexyl isocyanate (IMCI) and 1,5-naphthylene diisocyanate. Preferred organic difunctional isocyanates are IPDI, HMDI and HDI. Mixtures of organic difunctional isocyanates can also be used.

In general, the amount of component (A1) is from 5 to 55 wt. %, preferably from 10 to 45 wt. %, most preferably from 15 to 40 wt. %, based on the weight of the polyurethane.

### Component (A2)

At least one isocyanate-reactive compound that contains at least one salt group, preferably a salt of an acidic group, which is capable to render the polyurethane dispersible in water and/or at least one functional group, preferably an acidic group, that can be converted, by reaction with a neutralizing agent, into a salt group which is capable to render the polyurethane dispersible in water is used as component (A2).

In general, the amount of component (A2) is from 1 to 15 wt. %, preferably from 2 to 12 wt. % and even more preferably from 3 to 10 wt. %, based on the weight of the polyurethane.

According to the present invention, the acidic group is preferably selected from a carboxylic acid group, a sulfonic acid group and/or a phosphoric acid group. Component (A2) is preferably a compound having two or more hydroxy groups and/or two or more amino groups. Preferably at least one compound having two or more hydroxy groups is used as component (A2). A combination of at least one carboxylic acid group-containing compound and at least one sulfonic acid group-containing compound may be used. Preferred components (A2) are dihydroxy alkanoic acids and diamine sulfonate salts.

Preferably, at least one carboxylic acid group containing compound is used as component (A2).

In case component (A2) contains at least one functional group that can be converted by reaction with a neutralizing agent into a salt group, the neutralizing agent used to deprotonate (neutralize) the functional groups (preferably carboxylic acid groups, sulfonic acid groups and/or phosphoric acid groups, more preferably carboxylic acid groups) is preferably selected from the group consisting of ammonia, a (tertiary) amine, a metal hydroxide and any mixture thereof. Suitable tertiary amines include triethylamine and N,N-dimethylethanolamine. Suitable metal hydroxides include alkali metal hydroxides, for example lithium hydroxide, sodium hydroxide and potassium hydroxide. Preferably, at least 30 mol %, more preferably at least 50 mol % and most preferably at least 70 mol % of the total molar amount of the neutralizing agent is alkali metal hydroxide, preferably selected from the group consisting of lithium hydroxide, sodium hydroxide, potassium hydroxide and any mixture thereof. Preferably the neutralizing agent used to deprotonate (neutralize) the carboxylic acid groups, sulfonic acid groups and/or phosphoric acid groups is an alkali metal hydroxide. As used herein, the neutralizing agent (if any) is not to be considered a component from which the building blocks of the polyurethane are emanated. Thus, the amount of neutralizing agent (if any) used in the preparation of the polyurethane is not taking into account for the calculation of the weight of the polyurethane.

In an embodiment of the invention, component (A2) comprises or essentially consists of or consists of at least one diamine sulfonate salt. In this embodiment, usually an isocyanate-terminated polyurethane pre-polymer is first formed by the reaction of components (A1) and (A4) and optionally (A3) and optionally (A5) which is then further reacted with the diamine sulfonate salt (A2) and water and optionally a nitrogen containing chain extender compound (A6). A preferred diamine sulfonate salt is the sodium salt of 2-[(2-aminoethyl)amino]ethanesulfonic acid.

In a preferred embodiment of the invention, component (A2) comprises or essentially consists of or consists of at least one dihydroxy alkanoic acid. In this embodiment, usually an isocyanate-terminated polyurethane pre-polymer is first formed by the reaction of components (A1), (A2) and (A4) and optionally (A3) and optionally (A5) which is then chain extended with water and/or a nitrogen-containing chain extender compound (A6).

Preferred dihydroxy alkanoic acids are α,α-dimethylolpropionic acid and/or α,α-dimethylolbutanoic acid. More preferably, the dihydroxy alkanoic acid(s) is α,α-dimethylolpropionic acid.

The amount of acidic groups present in the polyurethane is preferably such that the theoretical acid value of the polyurethane is in the range from 5 to 50, more preferably from 10 to 40, even more preferably from 15 to 30 mg KOH/g solids of the polyurethane.

### Component (A3)

Optionally at least one isocyanate-reactive compound containing at least one non-ionic group which is capable to render the polyurethane dispersible in water, is used as component (A3).

The polyurethane may further be stabilized in the dispersion through non-ionic functionality incorporated into the polyurethane. Thus, the polyurethane may at least for a part be non-ionically stabilized by chemically incorporating non-ionic groups into the polyurethane to provide at least a part of the hydrophilicity required to enable the polyurethane to be stably dispersed in the aqueous dispersing medium. Preferred non-ionic water-dispersing groups are polyethylene oxide.

Preferred components (A3) are polyethylene glycols having at least 5 ethylene oxide repeating units, preferably at least 10, more preferably at least 15 ethylene oxide repeating units and preferably at most 120, more preferably at most 80 and even more preferably at most 40 ethylene oxide repeating units. More preferred components (A3) are polyethylene glycols having from 10 to 60 and preferably from 15 to 30 ethylene oxide repeating units.

Non-limited examples of suitable components (A3) include Ymer™ N120 available from Perstorp and MPEG 750.

In case component (A3) is used to prepare the polyurethane, the amount of component (A3) is in general from 1 to 15 wt. %, preferably from 1 to 12 wt. %, most preferably from 1 to 5 wt. %, based on the weight of the polyurethane.

### Component (A4)

At least one isocyanate-reactive compound having an OH number of from 25 to 225 mg KOH/g solids and being different from (A2) and (A3) is used as component (A4). Preferred components (A4) are polyols which may be selected from any of the chemical classes of polyols that can be used in polyurethane synthesis. In particular the polyol may be a polyester polyol, a polyesteramide polyol, a polyether polyol, a polythioether polyol, a polycarbonate polyol, a polyacetal polyol, a polyvinyl polyol and/or a polysiloxane polyol. Preferred are the polyester polyols, polyether polyols and polycarbonate polyols. Preferably the OH number of component (A4) is within the range of from 35 to 190 mg KOH/g solids, more preferably within the range of from 45 to 125 mg KOH/g solids. The OH number is given by the supplier and can be measured by titration of a known mass of alcohol according to ASTM D4274 and is expressed as mg KOH/g.

In general, the amount of component (A4) is from 20 to 80 wt. %, preferably from 30 to 70 wt. %, more preferably from 35 to 65 wt. %, based on the weight of the polyurethane.

### Component (A5)

Optionally at least one isocyanate-reactive compound having an OH number higher than 225 mg KOH/g solids and lower than 1850 mg KOH/g solids and being different from (A2) and (A3), is used as component (A5).

Examples of suitable components (A5) include neopentylglycol (NPG), cyclohexanedimethanol (CHDM), butanediol, hexanediol and trimethylolpropane.

In case component (A5) is used to prepare the polyurethane, the amount of component (A5) is in general from 0.5 to 10 wt. %, preferably from 1 to 8 wt. %, most preferably from 2 to 6 wt. %, based on the weight of the polyurethane.

### Component (A6)

Water and/or at least one nitrogen containing chain extender compound is used as chain extender component (A6).

For water extension, two NCO groups will form one urea bond. First a NCO group reacts with water to form an unstable carbamic acid intermediate that decomposes to CO₂ and an amine group, which amine group will then react with another NCO group to form a urea group. However, water extension is very slow compared to chain extension using a nitrogen containing chain extender. Therefore, if a nitrogen containing chain extender compound is applied, it is assumed for the calculation of the urea group concentration that the isocyanate groups of the polyurethane prepolymer first react with the nitrogen containing chain extender and that during and/or after dispersion the isocyanate groups still present on the polyurethane prepolymer react with water to form a urea group.

Examples of suitable nitrogen containing chain extenders include amino-alcohols, primary or secondary diamines or polyamines (including compounds containing a primary amino group and a secondary amino group), hydrazine and substituted hydrazines. Examples of such chain extender compounds useful herein include 2-(methylamino)ethylamine, aminoethyl ethanolamine, aminoethylpiperazine, diethylene triamine, and alkylene diamines such as ethylene diamine and 1,6-hexamethylenediamine, and cyclic amines such as isophorone diamine. Also compounds such as hydrazine, azines such as acetone azine, substituted hydrazines such as, for example, dimethyl hydrazine, 1,6-hexamethylene-bis-hydrazine, carbodihydrazide, hydrazides of dicarboxylic acids, such as adipic acid dihydrazide, oxalic acid dihydrazide, and isophthalic acid dihydrazide, Hydrazides made by reacting lactones with hydrazine, bis-semi-carbazide, and bis-hydrazide carbonic esters of glycols may be useful. Water-soluble nitrogen containing chain extenders are preferred.

Preferably the nitrogen containing chain extender compound is selected from the group consisting of amino-alcohols, primary or secondary diamines, hydrazine, substituted hydrazines, substituted hydrazides and any mixture thereof.

Where the chain extender is other than water, for example, a hydrazine, it may be added to the aqueous dispersion of the isocyanate-terminated polyurethane prepolymer or, alternatively, it may already be present in the aqueous medium when the isocyanate-terminated polyurethane prepolymer is dispersed therein. The chain extension may be conducted at convenient temperatures from about 5° C. to 95° C. or, more preferably, from about 10° C. to 60° C.

The total amount of nitrogen containing chain extender compound employed, if used, should be such that the ratio of active hydrogens in the chain extender to isocyanate groups in the polyurethane prepolymer preferably is in the range from 0.1:1 to 2:1, more preferably from 0.6:1 to 1.4:1 and especially preferred from 0.8 to 1.2.

Preferably, component (A6) is water or water and at least one nitrogen containing chain extender with a NHₓ (wherein x is 1 or 2) functionality of 2 or 3, more preferably with a NHₓ functionality of 2, wherein for a hydrazide the NH groups connected to the carbonyl groups are not considered chain extending groups. More preferably, component (A6) comprises at least one nitrogen containing chain extender with a NHₓ (wherein x is 1 or 2) functionality of 2 or 3, more preferably with a NHₓ functionality of 2, wherein for a hydrazide the NH groups connected to the carbonyl groups are not considered chain extending groups. Even more preferably, component (A6) is water and at least one nitrogen containing chain extender with a NHₓ (wherein x is 1 or 2) functionality of 2 or 3, more preferably with a NHₓ functionality of 2, wherein for a hydrazide the NH groups connected to the carbonyl groups are not considered chain extending groups. The nitrogen containing chain extender is preferably selected from the group consisting of diamines and/or dihydrazides.

### Vinyl Polymer

The vinyl polymer(s) is obtained by polymerizing of vinyl monomer(s) using a conventional free radical yielding initiator system. Suitable free radical yielding initiators include mixtures partitioning between the aqueous and organic phases. Suitable free-radical-yielding initiators include inorganic peroxides such as ammonium persulphate, hydrogen peroxide, organic peroxides, such as benzoyl peroxide, alkyl hydroperoxides such as t-butyl hydroperoxide and cumene hydroperoxide; dialkyl peroxides such as di-t-butyl peroxide; peroxy esters such as t-butyl perbenzoate and the like; mixtures may also be used. The peroxy compounds are in some cases advantageously used in combination with suitable reducing agents (redox systems) such as iso-ascorbic acid. Azo compounds such as azobisisobutyronitrile may also be used. Metal compounds such as Fe.EDTA (EDTA is ethylene diamine tetracetic acid) may also be usefully employed as part of the redox initiator system. The amount of initiator or initiator system to use is conventional, e.g. within the range of 0.05 to 6 wt. % based on the weight of vinyl monomer used.

Preferably at least 80 wt. %, more preferably at least 95 wt. % and most preferably 100 wt. % of the total weight of vinyl monomers used are of α,β-mono-unsaturated vinyl monomers. Examples of vinyl monomers include but are not limited to 1,3-butadiene, isoprene; trifluoro ethyl (meth)acrylate (TFEMA); dimethyl amino ethyl (meth)acrylate (DMAEMA); styrene, a-methyl styrene, (meth)acrylic amides and (meth)acrylonitrile; vinyl halides such as vinyl chloride; vinylidene halides such as vinylidene chloride; vinyl ethers; vinyl esters such as vinyl acetate, vinyl propionate, vinyl laurate; vinyl esters of versatic acid such as VeoVa 9 and VeoVa 10 (VeoVa is a trademark of Resolution); heterocyclic vinyl compounds; alkyl esters of mono-olefinically unsaturated dicarboxylic acids such as di-n-butyl maleate and di-n-butyl fumarate; dialkylitaconates such as dimethyltaconate, diethylitaconate, dibutylitaconate and in particular, esters of acrylic acid and methacrylic acid of formula CH₂═CR⁴—COOR⁵ wherein R⁴ is H or methyl and R⁵ is optionally substituted alkyl of 1 to 20 carbon atoms (more preferably from 1 to 8 carbon atoms) or cycloalkyl of 3 to 20 carbon atoms (more preferably from 3 to 6 carbon atoms) examples of which are methyl (meth)acrylate, ethyl (meth)acrylate, butyl (meth)acrylate (all isomers), octyl (meth)acrylate (all isomers), 2-ethylhexyl (meth)acrylate, isopropyl (meth)acrylate and n-propyl (meth)acrylate. Preferred monomers of formula CH₂═CR⁴—COOR⁵ include methyl (meth)acrylate, ethyl (meth)acrylate, butyl (meth)acrylate (all isomers), octyl (meth)acrylate (all isomers), ethyl hexyl acrylate (all isomers) and isobornyl (meth)acrylate.

The vinyl monomers may include vinyl monomers carrying functional groups such as cross-linker groups and/or water-dispersing groups. Such functionality may be introduced directly in the vinyl polymer by free-radical polymerisation, or alternatively the functional group may be introduced by a reaction of a reactive vinyl monomer, which is subsequently reacted with a reactive compound carrying the desired functional group. Examples of suitable vinyl monomers providing crosslinking groups include acrylic and methacrylic monomers having at least one free carboxyl or hydroxyl group, epoxy, acetoacetoxy or carbonyl group, such as acrylic acid and methacrylic acid, glycidyl acrylate, glycidyl methacrylate, aceto acetoxy ethyl methacrylate, allyl methacrylate, tetraethylene glycol dimethacrylate, divinyl benzene and diacetone acrylamide.

Vinyl monomers providing ionic or potentially ionic water-dispersing groups which may be used as additional vinyl monomers include but are not limited to (meth)acrylic acid, itaconic acid, maleic acid, citraconic acid and styrenesulphonic acid.

Vinyl monomers providing non-ionic water-dispersing groups include alkoxy polyethylene glycol (meth)acrylates, preferably having a number average molecular weight of from 140 to 3000, may also be used. Examples of such monomers which are commercially available include w-methoxypolyethylene glycol (meth)acrylates. The at least one vinyl polymer of the hybrid (A) preferably has a calculated glass transition temperature T_{g} of from −55° C. to 115° C., preferably from −20° C. to 115° C., more preferably from −5° C. to 115° C., more preferably from 35° C. to 115° C., more preferably from 45° C. to 115° C.

As used herein, the glass transition temperature is determined by calculation by means of the Fox equation. Thus, the T_{g} in Kelvin, of a copolymer having “n” copolymerised comonomers is given by the weight fractions W of each comonomer type and the T_{g}'s of the homopolymers (in Kelvin) derived from each comonomer (as listed, for example, in J. Brandrup, E. H. Immergut, Polymer handbook 4th edition p. VI 193) according to the equation:

$$1 / {T}_{g} = \sum ( {W}_{n} / {Tg}_{n} ) .$$

The calculated T_{g} in Kelvin may be readily converted to ° C. Preferably, at least 30 wt. %, more preferably at least 50 wt. % and even more preferably at least 70 wt. % of the total amount of vinyl monomer(s) used to prepare the vinyl polymer is selected from the group consisting of methyl methacrylate, n-butyl acrylate, n-butyl methacrylate, 2-ethyl hexyl acrylate, 2-octyl acrylate, styrene and mixtures of two or more of said monomers. Preferably, the vinyl monomer(s) used to prepare the vinyl polymer is selected from the group consisting of styrene, methyl methacrylate, ethyl acrylate, butyl acrylate, butyl methacrylate, 2-ethyl hexyl acrylate, 2-octyl acrylate and mixtures thereof. More preferably at least 30 wt. %, preferably at least 50 wt. % and more preferably at least 70 wt. % of the total amount of the vinyl monomer(s) used to prepare the vinyl polymer is styrene, methyl methacrylate, n-butyl acrylate, 2-ethyl hexyl acrylate, 2-octyl acrylate and mixtures thereof.

The vinyl polymer of the hybrid (A) preferably has a theoretical acid value of from 0 to 10 mg KOH/g solids of vinyl polymer, more preferably less than 8 mg KOH/g solids of vinyl polymer, more preferably less than 5 mg KOH/g solids of vinyl polymer, more preferably less than 3 mg KOH/g solids of vinyl polymer.

The polyurethane-vinyl polymer hybrid (A) present in the aqueous, radiation-curable coating composition of the present invention is essentially free of radiation-curable, ethylenically unsaturated bonds. As used herein, a polyurethane-vinyl polymer hybrid (A) that is essentially free of radiation-curable, ethylenically unsaturated bonds means that the radiation-curable ethylenically unsaturated bond concentration (also referred to as the C═C bond concentration) of the polyurethane-vinyl polymer hybrid (A) present in the aqueous, radiation-curable coating composition of the present invention is less than 0.20 meq C═C per g of hybrid (A), preferably less than 0.10 meq C═C per g of hybrid (A), more preferably less than 0.05 milliequivalents C═C per g of hybrid (A), more preferably less than 0.01 milliequivalents C═C per g of hybrid (A). As used herein, the amount of radiation-curable, ethylenically unsaturated bonds in the hybrid (A) is measured by iodometric titration, i.e. is measured by a titration method following the addition of a fixed excess amount of dodecyl mercaptane solution (0.25N) on said unsaturated groups (isopropyl alcohol IPA/toluene as solvent and KOH as catalyst); Allow to react for 3 minutes (base catalysed Michael addition of mercaptane to double bonds). Afterwards acetic acid is added to neutralize the KOH and an excess of iodine solution (0.1N) on dodecylmercaptane is added. The residual iodine is then titrated with sodium thiosulfate using a platinum electrode. Most preferably, the hybrid (A) does not contain radiation-curable ethylenically unsaturated bonds.

### Radiation-Curable Diluent (B)

The aqueous, radiation-curable coating composition comprises at least one radiation-curable diluent (B) with a molar mass less than 750 g/mol and with an acrylate functionality of from 2 to 5, preferably from 2 to 4. The molar mass of the radiation-curable diluents (B) is calculated from their corresponding molecular formulas indicating the numbers of each type of atom in the radiation-curable diluent. Thus, the molar mass of (B) is the calculated molar mass obtained by adding the atomic masses of all atoms present in the structural formula of the compound.

In a preferred embodiment of the invention, at least 10 wt. %, preferably at least 20 wt. %, more preferably at least 30 wt. %, more preferably at least 40 wt. %, more preferably at least 50 wt. %, more preferably at least 60 wt. %, more preferably at least 70 wt. %, more preferably at least 80 wt. %, more preferably at least 90 wt. % and most preferably 100 wt. % of the radiation-curable diluents (B) is selected from the group consisting of:
di(trimethylolpropane) tetra-acrylate (di-TMPTA) with the corresponding molecular formula C₂₄H₃₄O₉ and its corresponding molar mass of 467 g/mol,
di(trimethylolpropane) tetra-acrylate comprising alkoxy groups,
di(trimethylolpropane) tri-acrylate (di-TMP3A) with the corresponding molecular formula C₂₁H₃₂O₈ and its corresponding molar mass of 412 g/mol,
di(trimethylolpropane) tri-acrylate comprising alkoxy groups,
glyceryl propoxy triacrylate (GPTA) with the corresponding molecular formula C₂₁H₃₂O₉ and its corresponding molar mass of 428 g/mol,
glyceryl propoxy triacrylate comprising additional alkoxy groups,
pentaerythritol tetra-acrylate (PET4A) with the corresponding molecular formula C₁₇H₂₀O₈ and its corresponding molar mass of 352 g/mol,
pentaerythritol tetra-acrylate comprising alkoxy groups,
pentaerythritol tri-acrylate (PET3A) with the corresponding molecular formula C₁₄H₁₈O₇ and its corresponding molar mass of 298 g/mol,
pentaerythritol tri-acrylate comprising alkoxy groups,
trimethylolpropane triacrylate (TMPTA) with the corresponding molecular formula C₁₅H₂₀O₆ and its corresponding molar mass of 296 g/mol,
trimethylolpropane triacrylate comprising alkoxy groups,
dipropyleneglycol diacrylate (DPGDA) with the corresponding molecular formula C₁₂H₁₈O₅ and its corresponding molar mass of 242 g/mol,
dipropyleneglycol diacrylate comprising additional alkoxy groups,
and any mixture thereof.

In case radiation-curable diluent (B) comprises (additional) alkoxy groups, the maximum number of alkoxy groups is such that the molar mass remains lower than 750 g/mol.

In a more preferred embodiment of the invention, at least 10 wt. %, preferably at least 20 wt. %, more preferably at least 30 wt. % more preferably at least 40 wt. %, most preferably at least 50 wt. %, more preferably at least 60 wt. %, more preferably at least 70 wt. %, more preferably at least 80 wt. %, more preferably at least 90 wt. % and most preferably 100 wt. % of the radiation-curable diluents (B) is selected from the group consisting of:
di(trimethylolpropane) tetra-acrylate (di-TMPTA) with the corresponding molecular formula C₂₄H₃₄O₉ and its corresponding molar mass of 467 g/mol,
di(trimethylolpropane) tetra-acrylate comprising alkoxy groups,
di(trimethylolpropane) tri-acrylate (di-TMP3A) with the corresponding molecular formula C₂₁H₃₂O₈ and its corresponding molar mass of 412 g/mol,
di(trimethylolpropane) tri-acrylate comprising alkoxy groups,
glyceryl propoxy triacrylate (GPTA) with the corresponding molecular formula C₂₁H₃₂O₉ and its corresponding molar mass of 428 g/mol,
glyceryl propoxy triacrylate comprising additional alkoxy groups,
trimethylolpropane triacrylate (TMPTA) with the corresponding molecular formula C₁₅H₂₀O₆ and its corresponding molar mass of 296 g/mol,
trimethylolpropane triacrylate comprising alkoxy groups,
dipropyleneglycol diacrylate (DPGDA) with the corresponding molecular formula C₁₂H₁₈O₅ and its corresponding molar mass of 242 g/mol,
dipropyleneglycol diacrylate comprising additional alkoxy groups,
and any mixture thereof.

Preferably, at least one of the radiation-curable diluents (B) has an acrylate functionality of 2 or 3, as this advantageously may result in a more pronounced matting effect. The radiation-curable diluents (B) with an acrylate functionality of 2 are preferably selected from the group consisting of dipropyleneglycol diacrylate (DPGDA) (with the corresponding molecular formula C₁₂H₁₈O₅ and its corresponding molar mass of 242 g/mol); dipropyleneglycol diacrylate comprising additional alkoxy groups, preferably propoxy groups; and any mixture thereof.

The radiation-curable diluents (B) with an acrylate functionality of 3 are preferably selected from the group consisting of glyceryl propoxy triacrylate (GPTA) (with the corresponding molecular formula C₂₁H₃₂O₉ and its corresponding molar mass of 428 g/mol); glyceryl propoxy triacrylate comprising additional alkoxy groups, preferably propoxy groups; trimethylolpropane triacrylate (TMPTA) (with the corresponding molecular formula C₁₅H₂₀O₆ and its corresponding molar mass of 296 g/mol); trimethylolpropane triacrylate comprising alkoxy groups, preferably propoxy groups; di(trimethylolpropane) tri-acrylate (di-TMP3A) with the corresponding molecular formula C₂₁H₃₂O₈ and its corresponding molar mass of 412 g/mol; di(trimethylolpropane) tri-acrylate comprising alkoxy groups, preferably propoxy groups; pentaerythritol tri-acrylate (PET3A) (with the corresponding molecular formula C₁₄H₁₈O₇ and its corresponding molar mass of 298 g/mol); pentaerythritol tri-acrylate comprising alkoxy groups, preferably propoxy groups; and any mixture thereof. The radiation-curable diluents (B) with an acrylate functionality of 2 or 3 preferably comprises alkoxy groups, preferably propoxy groups (—C₃H₆O—).

Preferably, the composition further comprises at least one of the radiation-curable diluents (B) with an acrylate functionality of 4 or 5, as this advantageously may result in further improved chemical resistances. The radiation-curable diluents (B) with an acrylate functionality of 4 are preferably selected from the group consisting of di(trimethylolpropane) tetra-acrylate (di-TMPTA) (with the corresponding molecular formula C₂₄H₃₄O₉ and its corresponding molar mass of 467 g/mol); di(trimethylolpropane) tetra-acrylate comprising alkoxy groups, preferably propoxy groups; pentaerythritol tetra-acrylate (PET4A) (with the corresponding molecular formula C₁₇H₂₀O₈ and its corresponding molar mass of 352 g/mol); pentaerythritol tetra-acrylate comprising alkoxy groups, preferably propoxy groups; and any mixture thereof.

The radiation-curable diluents (B) with an acrylate functionality of 5 is preferably dipentaerythritol penta-acrylate (DPPA) with the corresponding molecular formula C₂₅H₃₂O₁₂ and its corresponding molar mass of 525 g/mol.

In a preferred embodiment, the aqueous, radiation-curable coating composition used in the process of the present invention comprises at least two radiation-curable diluents (B) and the radiation-curable diluents (B) present in the aqueous, radiation-curable coating composition

$$\overline{f} = \frac{{\sum }_{k} \frac{{w}_{k}}{{M}_{k}} {f}_{k}}{{\sum }_{k} \frac{{w}_{k}}{{M}_{k}}}$$

have an average acrylate functionality according to formula of from 2 to 4, preferably from 2 to 3, in which wₖ is the amount of acrylate diluents (B) in g present in the aqueous, radiation-curable coating composition with a molar mass MK and with an acrylate functionality fₖ We illustrate the average acrylate functionality calculation with a theoretical example:

For a formulation consisting of 60 grams of polyurethane-vinyl polymer hybrid, 30 grams of DPGDA (having molar mass 242 g/mol and acrylate functionality of 2), 10 grams of Di-TMPTA (having molar mass 466 g/mol and acrylate functionality of 4), and 2.5 grams of photoinitiator: the summation over components k includes only DPGDA and Di-TMPTA and the calculated average functionality of acrylate diluents of this theoretical formulation is

$$\overline{f} = \frac{\frac{30 g}{242 \frac{g}{mol}} \times 2 + \frac{10 g}{466 \frac{g}{mol}} \times 4}{\frac{30 g}{242 \frac{g}{mol}} + \frac{10 g}{466 \frac{g}{mol}}} = 2.3 .$$

The aqueous, radiation-curable coating composition used in the process may also comprise acrylate diluents with a molar mass as defined for the (B) compounds present in the radiation-curable coating composition (i.e. lower than 750 g/mol) but with a different acrylate functionality than defined for (B), for example with an acrylate functionality of 6. However, such acrylate diluents may only be present in the aqueous radiation-curable coating composition in such an amount that the average acrylate functionality of the acrylate diluents with a molar mass as defined for (B) (i.e. lower than 750 g/mol) is in the range of preferably from 2 to 5, more preferably from 2 to 4, even more preferably from 2 to 3.

Preferably, the aqueous, radiation-curable coating composition used in the process of the present comprises monofunctional diluent in an amount less than 7 wt. %, more preferably at less than 5 wt. %, more preferably less than 3 wt. %, more preferably less than 1 wt. %, most preferably less than 0.5 wt. %, relative to the weight of the entire aqueous, radiation-curable coating composition.

In an even more preferred embodiment of the invention, at least 60 wt. %, preferably at least 70 wt. %, more preferably at least 80 wt. %, more preferably at least 90 wt. % and most preferably 100 wt. % of the radiation-curable diluents (B) is a mixture of
(1) di(trimethylolpropane) tetra-acrylate (di-TMPTA) with the corresponding molecular formula C₂₄H₃₄O₉ and its corresponding molar mass of 467 g/mol and/or di(trimethylolpropane) tetra-acrylate comprising alkoxy groups, preferably propoxy groups and/or pentaerythritol tetra-acrylate (PET4A) with the corresponding molecular formula C₁₇H₂₀O₈ and its corresponding molar mass of 352 g/mol and/or pentaerythritol tetra-acrylate comprising alkoxy groups, preferably propoxy groups, and
(2) glyceryl propoxy triacrylate (GPTA) with the corresponding molecular formula C₂₁H₃₂O₉ and its corresponding molar mass of 428 g/mol and/or glyceryl propoxy triacrylate comprising additional alkoxy groups, preferably propoxy groups and/or dipropyleneglycol diacrylate (DPGDA) and/or dipropyleneglycol diacrylate comprising additional alkoxy groups, preferably propoxy groups.

The radiation-curable diluent (B) is added after having carried out the free-radical polymerization of vinyl monomer(s) to obtain the vinyl polymer of the polyurethane-vinyl polymer hybrid (A); and the polyurethane is preferably prepared in the presence of at least part of the one or more vinyl monomers used to prepare the vinyl polymer.

In the present invention, the polyurethane-vinyl polymer hybrid (A) preferably has a number-average molecular weight Mₙ of at least 10 kg/mol, preferably at least 15 kg/mol, more preferably of at least 20 kg/mol, even more preferably of at least 30 kg/mol. The polyurethane-vinyl polymer hybrids (A) preferably has a weight-average molecular weight Mw of at least 50 kg/mol, preferably of at least 100 kg/mol, more preferably of at least 150 kg/mol, more preferably of at least 200 kg/mol, more preferably of at least 300 kg/mol, more preferably of at least 400 kg/mol and most preferably of at least 500 kg/mol and can be even higher than the highest weight average molecular weight that can be measured with the method as used herein for determining the weight-average molecular weight. The number average molecular weight Mₙ and weight average molecular weight Mw are determined as described further herein.

The amounts of (A) and (B) in the aqueous, radiation-curable coating composition can vary within wide ranges as water and optional organic solvent can be used to adopt the viscosity and to tune the layer thickness of the applied coating. Preferably, the amount of (A) is from 35 to 80 wt. % and the amount of (B) is from 20 to 65 wt. %, more preferably the amount of (A) is from 40 to 80 wt. % and the amount of (B) is from 20 to 60 wt. %, based on the total amount of (A) and (B).

The summed amount of (A) and (B) is preferably from 10 to 60 wt. %, more preferably from 15 to 50 wt. %, more preferably from 15 to 45 wt. %, even more preferably from 20 to 40 wt. %, even more preferably from 25 to 35 wt. %, based on the entire weight of the aqueous, radiation-curable coating composition.

The amount of water in the aqueous, radiation-curable coating composition is preferably at least 30 wt. %, or at least 35 wt. %, or at least 40 wt. %, or at least 45 wt. %, or at least 50 wt. %, or at least 55 wt. %, or at least 60 wt. %, or at least 70 wt. %, based on the entire weight of the aqueous, radiation-curable coating composition.

The optional organic solvent is present in an amount of at most 30 wt. %, preferably at most 25 wt. %, more preferably at most 20 wt. %, more preferably in an amount of at most 15 wt. %, more preferably in an amount of at most 10 wt. %, more preferably in an amount of at most 5 wt. %, more preferably in an amount of at most 4 wt. %, more preferably in an amount of at most 3 wt. %, more preferably in an amount of at most 2 wt. %, more preferably in an amount of at most 1 wt. %, wherein the amount of organic solvent is given based on the total amount of water and organic solvent present in the aqueous, radiation-curable coating composition. Suitable organic solvents are solvents which are inert in respect of the functional groups present in the coating composition. Suitable solvents are for example hydrocarbons, alcohols, ketones and esters, such as co-solvents also having the function of coalescent such as 1-methyl-2-pyrrolidinone, glycols and glycol ethers such as butyldiglycol, dipropylene glycol methyl ether, acetone, methyl ethyl ketone and alkyl ethers of glycol acetates or mixtures thereof and ester alcohol like 2,2,4-trimethyl-1,3-pentanediol monoisobutyrate (Texanol). Most preferably the aqueous, radiation-curable coating composition is essentially free of organic solvent, i.e. organic solvent is preferably not deliberately be added (i.e. small amounts of organic solvent may be present in the additives used to prepare the composition) to the aqueous, radiation-curable coating composition.

(A) and (B) together preferably have a radiation-curable, ethylenically unsaturated bond concentration of from 0.8 to 5.0 milli-equivalents (meq) C═C per g of (A)+(B), preferably from 1.5 to 4 meq C═C per g of (A)+ (B). The amount of radiation-curable ethylenically unsaturated bonds in the hybrids (A) and the radiation-curable diluents (B) is measured by iodometric titration, i.e. is measured by a titration method following the addition of a fixed excess amount of dodecyl mercaptane solution (0.25N) on said unsaturated groups (isopropyl alcohol IPA/toluene as solvent and KOH as catalyst); Allow to react for 3 minutes (base catalysed Michael addition of mercaptane to double bonds). Afterwards acetic acid is added to neutralize the KOH and an excess of iodine solution (0.1N) on dodecylmercaptane is added. The residual iodine is then titrated with sodium thiosulfate using a platinum electrode.

The total amount of biobased carbon content in (A) and (B), relative to the total mass of carbon in (A) and (B), measured according to standard ASTM D6866-12, Method B, is preferably at least 5 wt. %, more preferably at least 10 wt. %, more preferably at least 20 wt. %, more preferably at least 30 wt. %, most preferably at least 40 wt. %, relative to the entire weight of (A) and (B).

The viscosity of the dispersion consisting of (A), (B) and (C) and containing from 10 to 60 wt. % of (A) and (B), relative to the total amount of (A), (B) and (C), is preferably from 10 to 1000 mPa·s, or from 10 to 800 mPa·s, or from 10 to 500 mPa·s. The viscosity is determined as further described herein.

The z-average particle size of the dispersion consisting of (A), (B) and (C) is preferably from 20 to 1000 nm, more preferably from 25 to 500 nm, even more preferably from 25 to 250 nm and most preferably from 30 to 200 nm, whereby the z-average particle size is determined as further described herein.

The aqueous, radiation-curable coating composition of the invention is preferably essentially free of tin and/or essentially free of tertiary amines. As used herein, essentially free of tin means that the radiation-curable coating composition contains tin in amount of preferably at most 50 ppm (relative to the aqueous, radiation-curable coating composition), more preferably at most 10 ppm, even more preferably at most 5 ppm, even more preferably at most 2 ppm and even more preferably the aqueous, radiation-curable coating composition of the invention does not contain tin. As used herein, essentially free of tertiary amines means that the radiation-curable coating composition contains tertiary amines like for example triethylamine in an amount of preferably at most 1.5 wt. % (relative to the aqueous, radiation-curable coating composition), more preferably at most 1 wt. %, even more preferably at most 0.5 wt. %, even more preferably at most 0.1 wt. % and even more preferably the aqueous, radiation-curable coating composition of the invention does not contain tertiary amine(s).

The coating composition usually further contains an additive compound; that is, a collection of one or more than one individual additives having one or more than one specified structure or type. Suitable additives are for example light stabilizers, such as UV absorbers and reversible free-radical scavengers (HALS), photosensitizers, antioxidants, degassing agents, wetting agents, emulsifiers, slip additives, waxes, polymerization inhibitors, adhesion promoters, flow control agents, film-forming agents, rheological aids such as thickeners, flame retardants, corrosion inhibitors, waxes, driers and biocides. One or more of the aforementioned additives can be employed in the coating composition used in the process of the present invention in any suitable amount and may be chosen singly or in combination of one or more of the types enumerated herein. In a preferred embodiment, the additive compound is present in an amount, relative to the entire weight of the radiation-curable coating composition, of from about 0 wt. % to 40 wt. %, or from 0 wt. % to 30 wt. %, or from 0 wt. % to 20 wt. %, or from 0 wt. % to 10 wt. %, or from 0 wt. % to 5 wt. %; or from 0.01 wt. % to 40 wt. %; or from 0.01 wt. % to 30 wt. %, or from 0.01 wt. % to 20 wt. %, or from 0.01 wt. % to 10 wt. %, or from 0.01 wt. % to 5 wt. %, or from 0.1 wt. % to 2 wt. %. An additional advantage of the present invention is that the coating composition can also be pigmented, while this does not significantly complicate the application of the coating composition on the substrate.

The coating composition then contains at least one pigment. In the art titanium dioxide (TiO₂) is considered as a commercially important white pigment. Despite the porous nature of this type of pigment, it has furthermore surprisingly been found that the presence of such type of pigments in the coating composition as defined herein, hardly impair the coffee, red wine and/or mustard resistance of the coating or only deteriorates to such an extent that the resistance to coffee, red wine and/or mustard remains at an acceptable level.

The coating composition can also contain one or more inorganic fillers. The coating composition can also contain external matting agents which have an additional matting effect, although this is not preferred. Suitable external matting agents are for example inorganic silica or organic waxes. The maximum amount of external matting agents is preferably at most 1.5 wt. %, more preferably at most 1 wt. % and most preferably at most 0.5 wt. %, relative to the entire weight of the coating composition.

The present invention further relates to a process for preparing the aqueous, radiation-curable coating composition of the present invention.

The process for preparing the aqueous, radiation-curable coating composition of the present invention comprises preparing an aqueous, radiation-curable dispersion comprising particles of the polyurethane-vinyl polymer hybrid (A), whereby the radiation-curable diluent (B) is added after having carried out the free-radical polymerization of vinyl monomer(s) to obtain the vinyl polymer of the polyurethane-vinyl polymer hybrid (A).

In the preferred embodiment of the invention in which component (A2) comprises or essentially consists of or consists of at least one dihydroxy alkanoic acid, the process for preparing the aqueous, radiation-curable coating composition preferably comprises
I. reacting components (A1), (A2) and (A4) and optionally (A3) and optionally (A5) to obtain a polyurethane pre-polymer,
II. (a) either blending the polyurethane pre-polymer with an aqueous phase comprising neutralizing agent and preferably comprising nitrogen containing chain extender compound compound (A6) to obtain a dispersion or (b.1) either neutralizing the polyurethane pre-polymer by adding neutralizing agent to the polyurethane pre-polymer and subsequently (b.2) adding the neutralized polyurethane prepolymer to water preferably comprising nitrogen containing chain extender compound (A6) to obtain a dispersion or (b.2′) adding water preferably comprising nitrogen containing chain extender compound (A6) to the neutralized polyurethane prepolymer to obtain a dispersion or (b.2″) adding the neutralized polyurethane prepolymer to water to obtain a dispersion and afterwards add the nitrogen containing chain extender compound (A6) to the dispersion, whereby
   vinyl monomer is added before, during or after preparation of the polyurethane, a free radical initiator is added to polymerize the vinyl monomer in the presence of the polyurethane, and
   the radiation-curable diluent (B) is added after having carried out the free-radical polymerization of vinyl monomer(s) to obtain the vinyl polymer of the polyurethane-vinyl polymer hybrid (A).

Any step of the foregoing can be carried out in the presence of a temporary solvent like acetone or MEK which is removed from the aqueous polyurethane-vinyl polymer hybrid (A) dispersion.

Step I is preferably carried out in the presence of at least part of the one or more vinyl monomers used to prepare the vinyl polymer.

In the preferred embodiment of the invention in which component (A2) comprises or essentially consists of or consists of at least one diamine sulfonate salt, the process for preparing the aqueous, radiation-curable coating composition according to the invention preferably comprises
I. reacting components (A1), (A4), and optionally (A3) and optionally (A5) to obtain a polyurethane prepolymer,
II. (II.1) adding the polyurethane prepolymer to water comprising diamine sulfonate salt (A2) and preferably comprising nitrogen containing chain extender compound (A6) to obtain a dispersion or (II.1′) adding water comprising diamine sulfonate salt (A2) and preferably comprising nitrogen containing chain extender compound (A6) and optionally further adding water to the polyurethane prepolymer to obtain a dispersion, whereby
vinyl monomer is added before, during or after preparation of the polyurethane, a free radical initiator is added to polymerize the vinyl monomer in the presence of the polyurethane, and
the radiation-curable diluent (B) is added after having carried out the free-radical polymerization of vinyl monomer(s) to obtain the vinyl polymer of the polyurethane-vinyl polymer hybrid (A).

Any step of the foregoing can be carried out in the presence of a temporary solvent like acetone or MEK which is removed from the aqueous polyurethane-vinyl polymer hybrid (A) dispersion.

Step I is preferably carried out in the presence of at least part of the one or more vinyl monomers used to prepare the vinyl polymer.

The process of the invention optionally comprises a pre-curing step (2a). Performing the pre-curing step (2a) may be advantageous for improving adhesion, in particular for improving intercoat adhesion. In this optional step (2a) pre-curing of the at least partially dried coating composition is effected, affording an at least partially cured coating composition. In optional step (2a) some of the reactive ethylenically unsaturated double bonds of the curable compounds polymerize in the uncured coating layer, so that the coating layer partially cures but is not yet fully cured. This process is also known as pre-curing.

Accordingly, the process of the invention comprises the steps in the sequence (1), (2), (2a), (3) and (4):
(1) Applying an aqueous, radiation-curable coating composition on a surface of a substrate,
(2) Drying the aqueous, radiation-curable coating composition, affording an at least partially dried coating composition,
(2a) Optionally pre-curing the at least partially dried coating composition by irradiating the at least partially dried coating composition with UV light having a wavelength of from 300 to 450 nm, preferably from 300 to 420 nm with a radiation dose which results in partial curing of the layer, preferably with a radiation dose from 20 to 200 mJ/cm², more preferably with a radiation dose from 30 to 100 mJ/cm², affording an at least partially cured coating composition,
(3) Irradiating the at least partially dried coating composition or the at least partially cured coating composition with UV light having a wavelength ≤220 nm preferably with a wavelength ≥120 nm, more preferably ≥150 nm, particularly preferably 172 nm or 195 nm, under inert atmosphere, followed by
(4) Irradiating with UV light having a wavelength >300 nm or with E-beam.

In step (1) of the process of the invention, the aqueous, radiation-curable coating composition is applied to a substrate by methods known to the person skilled in the art, such as for example knife coating, brushing, roller coating, spraying. The coating composition is applied to the substrate in a coating thickness (before drying) of preferably from 5 to 300 micron, more preferably from 15 to 175 micron, more preferably from 20 to 150 micron, more preferably from 25 to 125 micron.

In step (2) of the process of the invention, drying of the aqueous, radiation-curable coating composition that is applied to the substrate is preferably effected at a temperature higher than 30° C. to evaporate water and optionally organic solvent and other volatile compounds, affording an at least partially dried coating composition. The term “drying” refers to the loss of water and, if present, organic solvent and other volatile compounds such as for example neutralizing amines, from the aqueous coating composition by evaporation to such extend that preferably at least 80 wt. % of the water is removed.

The irradiating in the optional pre-curing step (2a) preferably takes place under atmospheric conditions, in other words not under inert gas conditions and/or not in an oxygen-reduced atmosphere. UV-A-emitting radiation sources (e.g. fluorescent tubes, LED lamps), high- or medium-pressure mercury vapour lamps, wherein the mercury vapour can be modified by doping with other elements such as gallium or iron, pulsed lamps (known as UV flash lamps) or halogen lamps are suitable as radiation sources for UV light in the specified wavelength range in step (2a). In a preferred embodiment of the invention, the process is performed without step (2a), i.e., the curing of the radiation-curable coating composition is effected in only 2 irradiation steps (i.e. step (3) and (4)).

Suitable radiation sources for step (3) are excimer UV lamps, which emit UV light with a wavelength ≤220 nm and preferably with a wavelength ≥120 nm, more preferably ≥150 nm, particularly preferably 172 nm or 195 nm. The radiation dose used in step (3) is usually in the range from 0.1 to 150 mJ/cm², preferably in the range of from 1 to 100 mJ/cm², more preferably from 1 to 20 mJ/cm², more preferably from 2 to 15 mJ/cm². Step (3) must be performed in an inert gas atmosphere. An inert gas atmosphere is understood to mean an essentially oxygen-free atmosphere, i.e. an atmosphere which contains less than 0.5 percent by volume of oxygen, preferably less than 0.1 percent by volume of oxygen and especially preferably less than 0.05 percent by volume of oxygen. As a rule, an inert gas atmosphere is achieved by flushing the area which is exposed to the UV radiation with a stream of inert gas. The inert gas atmosphere prevents undesired ozone formation on the one hand and prevents the polymerization of the lacquer layer from being inhibited on the other hand. Examples of inert gases are nitrogen, helium, neon or argon. Nitrogen is particularly preferably used. This nitrogen should only contain very small amounts of foreign gases such as oxygen, preferably with a purity grade of <300 ppm oxygen.

In step (4) of the process of the present invention, the coating layer obtained in step (3) is irradiated with UV light having a wavelength ≥(higher than or equal to) 300 nm or with E-beam to achieve that the radiation-curable compounds of the coating composition largely or preferably completely polymerizes, so that the coating layer is preferably fully cured. In case E-beam irradiation (150 to 300 kV) is applied in step (4), usually a dose of 10 to 100 kGy, preferably 20 to 50 kGy, is applied. In step (4) UV irradiation is preferred, preferably with a wavelength of from 300 to 420 nm and preferably with a radiation dose of from 100 to 2000 mJ/cm², more preferably from 150 to 1500 mJ/cm². High- and medium-pressure mercury vapour lamps can in particular be used as UV radiation sources, wherein the mercury vapour can be doped with further elements such as gallium or iron. Step (4) can optionally also be performed in an inert gas atmosphere. In case UV irradiation is applied in step (4), the radiation-curable coating composition comprises a photo-initiator. If the radiation curable coating composition of the invention comprise one or more photo-initiators, they are included in an amount sufficient to obtain the desired cure response. Typically, the one or more photo-initiators are included in amounts in a range of from 0.1 to 5% by weight of the entire coating composition. Preferably, the one or more photo-initiators are present in an amount, relative to the entire weight of the coating composition, of from 0.25 wt. % to 4 wt. %, more preferably from 0.5 wt. % to 3.5 wt. % and even more preferably from 0.5 wt. % to 3 wt. %. A photoinitiator is a compound that chemically changes due to the action of light or the synergy between the action of light and the electronic excitation of a sensitizing dye to produce at least one of a radical, an acid, and a base. Well-known types of photoinitiators include cationic photoinitiators and free-radical photoinitiators. According to an embodiment of the present invention, the photoinitiator is a free-radical photoinitiator.

In an embodiment, the photoinitiator compound includes, consists of, or consists essentially of one or more acylphosphine oxide photoinitiators. Acylphosphine oxide photoinitiators are known, and are disclosed in, for example, U.S. Pat. Nos. 4,324,744, 4,737,593, 5,942,290, 5,534,559, 6,020,529, 6,486,228, and 6,486,226. Preferred types of acylphosphine oxide photoinitiators for use in the photoinitiator compound include bisacylphosphine oxides (BAPO) or monoacylphosphine oxides (MAPO). More specifically, examples include 2,4,6-trimethylbenzoylethoxyphenylphosphine oxide (CAS #84434-11-7) or 2,4,6-trimethylbenzoyldiphenylphosphine oxide (CAS #127090-72-6).

In a preferred embodiment, the photoinitiator compound may also optionally comprise, consist of, or consist essentially of a-hydroxy ketone photoinitiators. For instance, suitable a-hydroxy ketone photoinitiators are a-hydroxycyclohexyl phenyl ketone, 2-hydroxy-2-methyl-1-phenylpropanone, 2-hydroxy-2-methyl-1-(4-isopropylphenyl) propanone, 2-hydroxy-2-methyl-1-(4-dodecylphenyl) propanone, 2-Hydroxy-1-{4-[4-(2-hydroxy-2-methyl-propionyl)-benzyl]-phenyl}-2-methyl-propan-1-one and 2-hydroxy-2-methyl-1-[(2-hydroxyethoxy)phenyl]propanone.

In another embodiment, the photoinitiator compound includes, consists of, or consists essentially of: α-aminoketones, such as 2-methyl-1-[4-(methylthio)phenyl]-2-(4-morpholinyl)-1-propanone, 2-benzyl-2-(dimethylamino)-1-[4-(4-morpholinyl)phenyl]-1-butanone, 2-(4-methylbenzyl-2-(dimethylamino)-1-[4-(4-morpholinyl)phenyl]-1-butanone or 2-benzyl-2-(dimethylamino)-1-[3,4-dimethoxyphenyl]-1-butanone; benzophenones, such as benzophenone, 2,4,6-trimethylbenzophenone, 4-methylbenzophenone, 2-methylbenzophenone, 2-methoxycarbonylbenzophenone, 4,4′-bis(chloromethyl)-benzophenone, 4-chlorobenzophenone, 4-phenylbenzophenone, 4,4′-bis(dimethylamino)-benzophenone, 4,4′-bis(diethylamino)benzophenone, methyl2-benzoylbenzoate, 3,3′-dimethyl-4-methoxybenzophenone, 4-(4-methylphenylthio)benzophenone, 2,4,6-trimethyl-4′-phenyl-benzophenone or 3-methyl-4′-phenyl-benzophenone; ketal compounds, for example 2,2-dimethoxy-1,2-diphenyl-ethanone; and monomeric or dimeric phenylglyoxylic acid esters, such as methylphenylglyoxylic acid ester, 5,5′-oxo-di(ethyleneoxydicarbonylphenyl) or 1,2-(benzoylcarboxy) ethane.

Yet further suitable photoinitiators for use in the photoinitiator compound include oxime esters, such as those disclosed in U.S. Pat. No. 6,596,445. Still another class of suitable photoinitiators for use in the photoinitiator compound include, for example, phenyl glyoxalates, for example those disclosed in U.S. Pat. No. 6,048,660.

In another embodiment, the photoinitiator compound may comprise, consist of, or consist essentially of one or more alkyl-, aryl-, or acyl-substituted compounds not mentioned above herein.

According to another embodiment, the composition may contain a photoinitiator that is an alkyl-, aryl-, or acyl-substituted compound. In an embodiment the alkyl-, aryl-, or acyl-substituted photoinitiator possesses or is centered around an atom in the Carbon (Group 14) group. In such instance, upon excitation (via absorption of radiation) the Group 14 atom present in the photoinitiator compound forms a radical. Such compound may therefore produce a radical possessing or centered upon an atom selected from the group consisting of silicon, germanium, tin, and lead. In an embodiment, the alkyl-, aryl-, or acyl-substituted photoinitiator is an acylgermanium compound. Such photoinitiators are described in, U.S. Pat. No. 9,708,442. Known specific acylgermanium photoinitiators include benzoyl trimethyl germane (BTG), tetracylgermanium, or bis acyl germanoyl (commercially available as Ivocerin® from Ivoclar Vivadent AG, 9494 Schaan/Liechtenstein).

Photoinitiators may be employed singularly or in combination of one or more as a blend. Suitable photoinitiator blends are for example disclosed in U.S. Pat. No. 6,020,528 and U.S. Pat. App. No. 60/498,848. According to an embodiment, the photoinitiator compound includes a photoinitiator blend of, for example, bis(2,4,6-trimethylbenzoyl) phenyl phosphine oxide (CAS #162881-26-7) and 2,4,6,-trimethylbenzoylethoxyphenylphosphine oxide (CAS #84434-11-7) in ratios by weight of about 1:11, 1:10, 1:9, 1:8 or 1:7.

Another especially suitable photoinitiator blend is a mixture of bis(2,4,6-trimethylbenzoyl)phenyl phosphine oxide, 2,4,6,-trimethylbenzoylethoxyphenylphosphine oxide and 2-hydroxy-2-methyl-1-phenyl-1-propanone (CAS #7473-98-5) in weight ratios of for instance about 3:1:15 or 3:1:16 or 4:1:15 or 4:1:16. Another suitable photoinitiator blend is a mixture of bis(2,4,6-trimethylbenzoyl)phenyl phosphine oxide and 2-hydroxy-2-methyl-1-phenyl-1-propanone in weight ratios of for instance about 1:3, 1:4 or 1:5.

One or more of the aforementioned photoinitiators can be employed for use in the photoinitiator compound in compositions according to the present invention in any suitable amount and may be chosen singly or in combination of one or more of the types enumerated herein. In a preferred embodiment, the photoinitiator compound comprises, consists of, or consists essentially of free-radical photoinitiators, preferably of the a-cleavage type.

Suitable substrates for the process according to the invention are for example mineral substrates such as fiber cement board, wood, wood containing materials, paper including cardboard, textile, leather, metal, thermoplastic polymer, thermosets, ceramic, glass. Suitable thermoplastic polymers are for example polyvinylchloride PVC, polymethylmethacrylate PMMA, acrylonitrile-butadiene-styrene ABS, polycarbonate, polypropylene PP, polyethylene PE, polyamide PA, polyethylene terephthalate PET and polystyrene PS. Suitable thermosets are for example linoleum, epoxy, melamine, novolac, polyesters and urea-formaldehyde.

The substrate is optionally pre-treated and/or optionally pre-coated. For example, thermoplastic plastic films can be treated with corona discharges before application or pre-coated with a primer. Mineral building materials are also usually provided with a primer before the coating composition is applied.

The coating obtained in the process of the invention can advantageously be used in a floor or wall covering or in automotive interior or on furniture.

With the process of the invention, low gloss coatings can advantageously be obtained with a dry thickness of at least 2 micron, or of at least 3 micron, or of at least 4 micron, and of at most 100 micron, or of at most 75 micron, or of at most 50 micron.

The present invention further relates to the aqueous, radiation-curable coating composition as described herein above. The present invention further relates to a coated substrate that is obtained by coating a substrate with the process as described herein above.

The present invention is now illustrated by reference to the following examples. Unless otherwise specified, all parts, percentages and ratios are on a weight basis.

### Measurement Methods

### Average Particle Size PS:

The intensity average particle size, z-average, has been determined by photon correlation spectroscopy using a Malvern Zetasizer Nano ZS. Samples are diluted in demineralized water to a concentration of approximately 0.1 g dispersion/liter. Measurement temperature 25° C. Angle of laser light incidence 173°. Laser wavelength 633 nm.

pH

The pH was measured using a Metrohm PH meter.

### Solids

The solid content of the dispersion was measured on a HB43-S halogen moisture analyzer from Mettler Toledo at a temperature of 75° C.

### Viscosity

The viscosity was determined using a Brookfield LV (spindle 2 at 60 rpm, room temperature)

Number Average Molecular Weight, Weight Average Molecular Weight, z-Average Molecular Weight and Molecular Weight Distribution

The number average molecular weight, weight average molecular weight, z-average molecular weight and molecular weight distribution is determined with Size exclusion chromatography with three PLgel 10 μm Mixed-B columns at 70° C. on a Waters Alliance 2695 LC system with a Waters 2410 DRI detector and a Waters 2996 PDA detector. Dimethylformamide (DMF) with 10 mmol lithium bromide (LiBr) is used as eluent with a flow of 1 mL/min. The samples are dissolved in the eluent using a concentration of 5 mg polymer per mL solvent. The solubility is judged with a laser pen after 24 hours stabilization at room temperature; if any scattering is visible the samples are filtered first using a 0.45 μm PTFE filter and a 150 μl sample solution is injected. The Mₙ (number average molecular weight), Mw (weight average molecular weight) and MWD (molecular weight distribution) results are calculated with narrow polystyrene standards from 474 to 1.730.000 Da supplied by Agilent. In general, a series of average molecular weights can be defined by the equation: M=ΣNᵢMⁿ⁺¹/ΣNᵢMᵢⁿ, whereby: n=0 gives M=Mₙ; n=1 gives M=Mw, n=2 gives M=M_{z}. The higher averages are increasingly more sensitive to high molecular weight polymers. Nᵢ is the number of molecules with molecular weight Mᵢ.

### Gloss

The gloss is determined according to ISO2813 in the direction of the drawdown and is expressed in gloss units (GU).

### Stain Resistances

The coffee, red wine and mustard resistances were determined colorimetric using an exact Standard Handheld Spectrophotometer from X-rite and are reported in Tables 5 and 6. For coffee, the spot exposure time was 1 hr resp. 6 hr and was rated after 24 hrs. For red wine and mustard, the spot exposure time was 6 hr and was rated after 24 hrs The a- and b-values were measured according to ISO 7724. The coffee and mustard resistances were determined by Δb value where Δb-value=b_{(after resp 6 and 1 hr coffee exposure or 6 hr mustard exposure and rated after 24 hours)}−b_{(before exposure)}. A higher Δb value indicates larger colour change due to staining, therefore worse stain resistance performance. The red wine resistance was determined colorimetric using Δa value where Δa-value=a_{(after 6 hr red wine exposure and rated after 24 hours)}−a_{(before exposure)}. A higher Δa value indicates larger colour change due to staining, therefore worse stain resistance performance. The a* axis is relative to the green-red opponent colours, with negative values toward green and positive values toward red. The b* axis represents the blue-yellow opponents, with negative numbers toward blue and positive toward yellow.

### Method to Calculate the Urea Content in Polyurethane

As known by a person skilled in the art, the concentration of urea bonds in polyurethane in meq/g solids is determined by calculation according to the formula given below.

$$Urea content PU ( A ) = ( ( ( Total NCO — Total OH — Total {NH}_{x} ) * ED * ( {AF}_{CE} / {AH}_{CE} ) ) + ( ( Total NCO — Total OH — Total {NH}_{x} ) * ( 1 - ED ) * 0.5 ) + Total {NH}_{x} ) * 1000 / {W}_{PU ( A )}$$

wherein
Total NCO: the number of NCO groups in moles originating from component (A1),
Total OH: the number of alcohol groups in moles originating from component (A2) to (A5),
Total NHₓ: the total number of amine (NHₓ where x=1 or 2) groups in moles originating from component (A2) to (A3)
W_{PU(A)}: total weight of polyurethane [components (A1)-(A6)] in grams,
ED: extension degree: the molar ratio of active hydrogens in the nitrogen containing chain extender (A6) to theoretical residual isocyanate groups in the polyurethane prepolymer (=Total NCO−Total OH−Total NHₓ),
AH_{CE}: Number of active hydrogens in the nitrogen containing chain extender (A6) where each NHₓ (wherein x=1 or 2) functionality counts as one active hydrogen, except for hydrazides in which the NH groups connected to the carbonyl groups are not considered chain extending groups.
AF_{CE}: NHₓ functionality of the nitrogen containing chain extender (A6) wherein x=1 or 2 and wherein for a hydrazide the NH groups connected to the carbonyl groups are not considered chain extending groups.

We illustrate this calculation with the following theoretical examples.

Calculation of urea group content in polyurethane for theoretical examples I-VI

Prepolymer composition theoretical examples I-V

| | Gram | mol NCO | Mol OH |
|---|---|---|---|
| IPDI [A1] | 40.7 | 0.366 | |
| PPG1000 [OHV 112.5 mg KOH/g] | 54.2 | | 0.108 |
| [A4] | | | |
| DMPA [A2] | 5 | | 0.075 |
| Total NCO [mol] | | 0.366 | |
| Total OH [mol] | | | 0.183 |

| | Theoretic | Theoretic | Theoretic | Theoretic | Theoretic |
|---|---|---|---|---|---|
| | Ex I | Ex II | Ex III | Ex IV | Ex. V |
| ED [—] | 0.9 | 0.9 | 0 [full water | 0.9 | 0.9 |
| | | | extension] | | |
| Hydrazine [A6] | 2.76 (0.082 | — | — | — | — |
| 32 g/mol [100%] | mol) | | | | |
| AF_{CE} = 2, AH_{CE} = 2 | | | | | |
| Diethylenetriamine [A6] | — | — | — | 5.7 (0.055 | — |
| 103.2 g/mol [100%] | | | | mol) | |
| AF_{CE} = 3, AH_{CE} = 3 | | | | | |
| Ethanolamine [A6] | — | 5.03 (0.082 | — | — | — |
| 61.08 g/mol [100%] | | mol) | | | |
| AF_{CE} = 1, AH_{CE} = 2 | | | | | |
| Adipic dihydrazide [A6] | — | — | — | — | 14.3 (0.082 |
| 174.2 g/mol | | | | | mol) |
| AF_{CE} = 2, AH_{CE} = 2 | | | | | |
| W_{PUA} [g] | 102.6 | 104.9 | 99.9 | 105.6 | 114.2 |
| Urea content [meq/g] | 1.7 | 0.9 | 0.9 | 1.6 | 1.5 |

Prepolymer composition theoretical example VI

| | Gram | mol NCO | Mol OH | Mol NHₓ |
|---|---|---|---|---|
| IPDI [A1] | 40.7 | 0.366 | | |
| PPG1000 [OHV 112.5 mg KOH/g] [A4] | 54.2 | | 0.108 | |
| DMPA [A2] | 5 | | 0.075 | |
| Vestamin A-95 [A2] | 35.4 | | | 0.164 |
| Sodium N-(2- | | | | |
| Aminoethyl)Aminoethanesulfonate | | | | |
| (51% w/w solution in water) | | | | |
| Amine number 260 mg KOH/g of the | | | | |
| aqueous solution | | | | |
| Total NCO [mol] | | 0.366 | | |
| Total OH [mol] | | | 0.183 | |
| Total NHₓ | | | | 0.164 |

| | |
|---|---|
| ED [—] | 0 [water extension] |
| W_{PUA} [g] | 118.0 |
| Urea content [meq/g] | 1.5 |

### Method to Calculate the Dry Film Thickness

The dry film thickness is calculated by multiplying the wet film thickness times the solids content of the formulation used.

$$DFT = WFT * solids content / 100$$

Where
DFT: dry film thickness in μm
WFT: wet film thickness in μm
Solids content (wt. %): total weight of all solid compounds present in formulation divided by (total weight of the formulation*100).

### Components and Abbreviations Used:

IPDI=Isophorone diisocyanate available from Covestro
HDI=hexane diisocyanate available from Covestro
Desmodur® W=DesW=HMDI=dicyclohexylmethane diisocyanate available from Covestro
DMPA=dimethylolpropionic acid available from Perstorp polyols
PPG2000=1,2-polypropylene glycol, OH-number=56 mg KOH/g available from BASF
Velvetol H2000=1,3-polypropylene glycol, OH-number=56 mg KOH/g available from Alessa
Priplast 3192=Polyester polyol, OH-number=56 mg KOH/g available from Croda
pTHF650=polytetramethylene glycol, OH-number=173 mg KOH/g available from BASF
Ymer™ N120=nonionic diol, OH-number=110 mg KOH/g available from Perstorp
MMA=methyl methacrylate
BA=n-butyl acrylate
OA=2-octyl acrylate
NPG=neopentylglycol available from Perstorp
TEA=triethylamine from Arkema
DPGDA=Agisyn™ 2833, dipropyleneglycoldiacrylate, available from Covestro
GPTA=Agisyn™ 2837, propoxylated (3) glycerol triacrylate available from Covestro
DiTMPTA=Agisyn™ 2887 TF, ditrimethylolpropane tetraacrylate available from Covestro
EO-PETIA=Agisyn™2844, ethoxylated (5) pentaerytritol tetraacrylate available from Covestro
DPHA=Agisyn™ 2830L, dipentaerythritolhexaacrylate, available from Covestro
EGDMA=ethyleneglycoldimethacrylate available from Covestro
BHT=butylated hydroxyl toluene available from Brenntag
Hydrazine=Hydrazine hydrate (16%) available from Arkema
Vestamin A 95=Sodium N-(2-Aminoethyl)Aminoethanesulfonate (51% w/w solution in water) available from Evonik
EDA=ethylenediamine available from Caldic
BismuthND=bismuthneodecanoate catalyst available from Reaxis
Omnirad 500=photoinitiator available from IGM
BYK 346=Surfactant available from BYK (45% solids)
BYK011=defoamer available from BYK
Butylglycol=solvent available from Aldrich
TEGO® Airex 902W=defoamer available from Evonik (24% solids)
Borchi® Gel L 75 N=Rheology modifier available from Borchers (50% solids)
Acematt® TS 100=silica matting agent from Evonik

### Preparation of a Polyurethane Dispersion (PUD 1)

A 2000 cm³ flask equipped with a thermometer and overhead stirrer was charged with components DMPA (37.4 g), PPG2000 (423.4 g) and IPDI (163.0 g). The reaction was heated to 50° C. Then 0.04 g of BismuthNeodecanoate was added. After the exotherm was complete the reaction was kept at 90° C. for 120 minutes. The NCO content of the resultant isocyanate-terminated prepolymer was 3.16% (theoretically 3.29%). The prepolymer was cooled down to 80° C. and TEA was added (28.3 g) and mixed for 10 minutes at 80° C.

A dispersion of the resultant isocyanate-terminated prepolymer was made by feeding 500 g of the resulting prepolymer mixture in 45 minutes to deionized water (850 g) containing 0.5 g Tegofoamex 805.

The dispersion temperature was controlled between 25 to 30° C. Hydrazine (32.4 g of the 16% aqueous solution) was added after the feed was completed. The solid content of the resulting dispersion was 34.2 wt %

### Preparation of Polyurethane-Vinyl Polymer Hybrid Resin Dispersion (UA Ex. 1-4 and UA Ex. 11-12)

In a 1000 cm³ flask 319.1 gram of the dispersion prepared in stage 1 (PUD 1) was mixed with 43.7 g of deionized water, 27.4 g MMA and 0.5 g BA under nitrogen atmosphere. After 45 minutes tertiary butyl hydroperoxide tBHPO (0.8 g (10% in water)) and Fe(II)EDTA (0.08 g (1% solution in water)) were added. Subsequently, a solution of iAA (isoascorbic acid) in water (1%, 8.4 g) neutralized with ammonia was slowly fed to the PU dispersion via a dropping funnel over a period of 15 minutes. The resulting polyurethane-vinyl polymer hybrid dispersion had a solid content of 34.4 wt % solids and a pH of 7.8

Table 1 specifies the components and its amounts applied for preparing the polyurethane-vinyl polymer hybrid resin dispersions of UA example 1-4 and 11 and 12. Unless specified otherwise, the amounts of the different components are expressed in grams.

TABLE 1
Composition of UA Ex. 1-4 and UA Ex. 11 and 12

| | UA Ex. 1 | UA Ex. 2 | UA Ex. 3 | UA Ex. 4 | UA Ex. 11 | UA Ex. 12 |
|---|---|---|---|---|---|---|
| PUD 1 | 319.1 | 319.1 | 319.1 | 159.1 | 319.1 | 238.9 |
| Water | 43.7 | 43.7 | 43.7 | 179.6 | 43.7 | 83.7 |
| MMA | 27.4 | 21.4 | 13.1 | 39.3 | — | — |
| Styrene | — | — | — | — | 21.8 | 26.7 |
| BA | 0.5 | 6.6 | 14.8 | 44.3 | 6.1 | 29.1 |
| tBHPO (10%) | 0.8 | 0.8 | 0.8 | 2.5 | 0.8 | 1.7 |
| Fe(II)EDTA | 0.08 | 0.08 | 0.08 | 0.3 | 0.08 | 0.17 |
| (1%) | | | | | | |
| isoascorbic acid | 8.4 | 8.4 | 8.4 | 25.1 | 8.4 | 16.7 |
| (1%), pH > 8 | | | | | | |

### Preparation of a Polyurethane Vinyl Polymer Hybrid Resin Dispersion (UA Ex. 5)

A 2000 cm³ flask equipped with a thermometer and overhead stirrer was charged with components PPG2000 (189.8 g), NPG (12.5 g) and IPDI (71.5 g). The reaction was heated to 50° C. and 0.03 g of BismuthNeodecanoate was added. After the exotherm was complete the reaction was kept at 95° C. for 120 minutes. The mixture was cooled down to 40° C. and 410 g of acetone was added. The NCO content of the resultant isocyanate-terminated prepolymer solution was 1.26%. A mixture of EDA (2.5 g) and Vestamin A95 (19.4 g) was added over 15 minutes. Subsequently a dispersion was made by feeding water (522 g). Then BYK011 was added (0.03 g) and the acetone was removed from the dispersion by distillation under vacuum. The solid content of the resulting PUD was 34.6 wt %

To 200 gr of the resulting dispersion, 25 g water, 13.3 g MMA and 4.1 g BA were added under nitrogen atmosphere and mixed for 45 minutes at room temperature. Subsequently, 0.52 g of a 10% tBHPO solution and 0.05 g of an 1% Fe(II)EDTA solution were added. Finally, 5.2 g of a 1% isoascorbic acid solution was fed to the dispersion over 10 minutes. The specifications of the resulting polyurethane-vinyl polymer hybrid are given in Table 2.

### Preparation of a Polyurethane-Vinyl Polymer Hybrid Resin Dispersion (UA Ex. 6)

A 2000 cm³ flask equipped with a thermometer and overhead stirrer was charged with components PPG2000 (168.6 g), DMPA (14.9) and IPDI (64.9 g). The reaction was heated to 50° C. and 0.03 g of BismuthNeodecanoate was added. After the exotherm was complete the reaction was kept at 95° C. for 120 minutes. The mixture was cooled down to 40° C. and 62 g of acetone was added. The NCO content of the resultant isocyanate-terminated prepolymer solution was 2.33%. A 15% KOH solution (29.1 g) was added slowly. Subsequently a dispersion was made by feeding water (537 g). The isocyanate-terminated prepolymer was chain extended with water. Then BYK011 was added (0.04 g) and the acetone was removed from the dispersion by distillation under vacuum. The solid content of the resulting PUD was 38.6 wt. %

To 181 gr of the resulting dispersion, 45 g water, 13.3 g MMA and 4.1 g BA were added under nitrogen atmosphere and mixed for 45 minutes at room temperature. Subsequently, 0.52 g of a 10% tBHPO solution and 0.05g of an 1% Fe(II)EDTA solution were added. Finally, 5.2 g of a 1% isoascorbic acid solution was fed to the dispersion over 10 minutes. The specifications of the resulting polyurethane-vinyl polymer hybrid are given in Table 2.

### Preparation of a Polyurethane-Vinyl Polymer Hybrid Resin Dispersion (UA Ex. 7)

A 2000 cm³ flask equipped with a thermometer and overhead stirrer was charged with components Velvetol H2000 (282.3 g), DMPA (25.0g) and IPDI (108.7 g). The reaction was heated to 50° C. and 0.04 g of BismuthNeodecanoate was added. After the exotherm was complete the reaction was kept at 95° C. for 120 minutes. The NCO content of the resultant isocyanate-terminated prepolymer was 3.14%. After cooling down to 80° C., TEA (18.8 g) was added and mixed for 15 minutes.

A dispersion of the resultant isocyanate-terminated prepolymer was made by feeding 290 g of the resulting prepolymer mixture in 45 minutes to deionized water (502 g). The dispersion temperature was controlled between 25 to 30° C. Hydrazine (16% in water, 18.64 g) was added after the feed was completed. The solid content of the resulting dispersion was 33.5 wt. %.

To 209 gr of the resulting dispersion, 18.2 g water, 13.3 g MMA and 4.1 g OA were added under nitrogen atmosphere and mixed for 45 minutes at room temperature. Subsequently, 0.52 g of a 10% tBHPO solution and 0.05 g of an 1% Fe(II)EDTA solution were added. Finally, 5.2 g of a 1% isoascorbic acid solution (pH>7) was fed to the dispersion over 10 minutes. The specifications of the resulting polyurethane-vinyl polymer hybrid are given in Table 2.

### Preparation of a Polyurethane-Vinyl Polymer Hybrid Resin Dispersion (UA Ex. 8)

A 1000 cm³ flask equipped with a thermometer and overhead stirrer was charged with components DMPA (24.9 g), Priplast 3192 (353.1 g), MMA (125.2 g), BHT (0.125 g) and IPDI (120.8 g). The reaction was heated to 50° C. Then 0.1 g of BismuthNeodecanoate was added. After the exotherm was complete the reaction was kept at 90° C. for 150 minutes. The NCO content of the resultant isocyanate-terminated prepolymer was 2.29% (theoretically 2.45%). The prepolymer was cooled down to 80° C. and TEA was added (18.8 g) and mixed for 10 minutes at 80° C.

A dispersion of the resultant isocyanate-terminated prepolymer was made by feeding 286 g of the resulting prepolymer mixture in 45 minutes to deionized water (580 g) under nitrogen atmosphere. The dispersion temperature was controlled between 25 to 30° C. Hydrazine (13.6 g) was added after the feed was completed.

Subsequently, tBHPO (2.8 g (10% in water)) and Fe(II)EDTA (0.28 g (1% in water)) were added to the dispersion followed by isoascorbic acid (16.7 g (1% in water)) (pH>7), which was slowly fed over a period of 15 minutes. The resulting polyurethane-vinyl polymer hybrid dispersion had a solid content of 30.9 wt % solids and a pH of 7.8. The specifications of the resulting polyurethane-vinyl polymer hybrid are given in Table 2.

### Preparation of a Polyurethane-Vinyl Polymer Hybrid Resin Dispersion (UA Ex. 9)

A dispersion of the isocyanate-terminated prepolymer from UA Ex. 8 was made by feeding 178 g of the resulting prepolymer mixture in 45 minutes to deionized water (450 g) under nitrogen atmosphere. The dispersion temperature was controlled between 25 to 30° C. Hydrazine (8.5 g) was added after the feed was completed. Subsequently, MMA (71.6 g) and BA (32.6 g) were charged to the polyurethane dispersion and mixed for 45 minutes. Afterwards, tBHPO (6.9 g (10% in water)) and Fe(II)EDTA (0.7 g (1% in water)) were added to the dispersion followed by isoascorbic acid (42 g (1% in water)) (pH>7), which was slowly fed over a period of 15 minutes. The resulting polyurethane-vinyl polymer hybrid dispersion had a solid content of 35.7 wt % solids and a pH of 7.8. The specifications of the resulting polyurethane-vinyl polymer hybrid are given in Table 2.

Preparation of a polyurethane-vinyl polymer hybrid resin dispersion (UA Ex. 10)

A 2000 cm³ flask equipped with a thermometer and overhead stirrer was charged with components pTHF2000 (229.5 g), DMPA (16.6 g), BHT (0.08 g), MMA (83.5 g), DesW (73.5 g) and HDI (13.0 g). The reaction was heated to 50° C. and 0.07 g of BismuthNeodecanoate was added. After the exotherm was complete the reaction was kept at 90° C. for 150 minutes. The NCO content of the resultant isocyanate-terminated prepolymer was 2.36%. After cooling down to 80° C., TEA (12.6 g) was added and mixed for 15 minutes.

A dispersion of the resultant isocyanate-terminated prepolymer was made by feeding 286 g of the resulting prepolymer mixture in 45 minutes to deionized water (808 g) under nitrogen atmosphere. The dispersion temperature was controlled between 25 to 30° C. Hydrazine (16% in water, 14.0 g) was added after the feed was completed.

Subsequently, 0.4 g of a 10% tBHPO solution and 0.28 g of a 1% Fe(II)EDTA solution were added. Finally, 17 g of a 1% isoascorbic acid solution (pH>7) was fed to the dispersion over 10 minutes. The specifications of the resulting polyurethane-vinyl polymer hybrid are given in Table 2.

### Preparation of a Polyurethane-Vinyl Polymer Hybrid Resin Dispersion (UA CEx. 1)

A 2000 cm³ flask equipped with a thermometer and overhead stirrer was charged with components pTHF650 (110.2 g), NPG (13.0 g), DMPA (16.2 g), BHT (0.08 g), MMA (83.6 g) and IPDI (184.7 g). The reaction was heated to 50° C. and 0.07 g of BismuthNeodecanoate was added. After the exotherm was complete the reaction was kept at 90° C. for 150 minutes. The NCO content of the resultant isocyanate-terminated prepolymer was 8.35%. After cooling down to 80° C., TEA (12.2 g) was added and mixed for 15 minutes.

A dispersion of the resultant isocyanate-terminated prepolymer was made by feeding 280 g of the resulting prepolymer mixture in 45 minutes to deionized water (453 g) under nitrogen atmosphere. The dispersion temperature was controlled between 25 to 30° C. Hydrazine (16% in water, 48.6 g) was added after the feed was completed.

Subsequently, 0.4 g of a 10% tBHPO solution and 0.28 g of a 1% Fe(II)EDTA solution were added. Finally, 17 g of a 1% isoascorbic acid solution (pH>7) was fed to the dispersion over 10 minutes. The specifications of the resulting polyurethane-vinyl polymer hybrid are given in Table 2.

TABLE 2
Specifications of UA Ex. 1 to 12 and Comparative Experiments UA CEx. 1

| | UA Ex. 1 | UA Ex. 2 | UA Ex. 3 | UA Ex. 4 | UA Ex. 5 | UA Ex. 6 | UA Ex. 7 |
|---|---|---|---|---|---|---|---|
| U/A ratio (weight ratio | 80/20 | 80/20 | 80/20 | 40/60 | 80/20 | 80/20 | 80/20 |
| polyurethane to vinyl | | | | | | | |
| polymer in hybrid (A)) | | | | | | | |
| Acid value hybrid (A) | 19.9 | 19.9 | 19.9 | 14.9 | 8.0 | 19.9 | 19.9 |
| [mg KOH/g (A)] | | | | | | | |
| Tg vinyl polymer | 100 | 50 | 0 | 0 | 50 | 50 | 50 |
| phase [° C.] | | | | | | | |
| Urea content in the | 0.74 | 0.74 | 0.74 | 0.74 | 0.72 | 0.39 | 0.74 |
| polyurethane [meq/g | | | | | | | |
| PU] | | | | | | | |
| Solid content [wt %] | 34.4 | 34.7 | 34.7 | 31.3 | 36.4 | 35.5 | 36.0 |
| Mn [kg/mole] | 61.4 | 50.3 | 71.9 | 68.6 | 47 | 39.5 | 85.9 |
| Mw [kg/mole] | 1547 | 1636 | 1577 | 2557 | 503 | 1075 | 1728 |
| pH | 7.8 | 7.8 | 7.8 | 7.7 | 7.6 | 7.4 | 7.9 |
| PS [nm] | 55 | 58 | 46 | 118 | 88 | 71 | 42 |

| | UA Ex. 8 | UA Ex. 9 | UA Ex. 10 | UA Ex. 11 | UA Ex. 12 | UA CEx. 1 |
|---|---|---|---|---|---|---|
| U/A ratio | 80/20 | 50/50 | 80/20 | 80/20 | 60/40 | 80/20 |
| Acid value hybrid (A) | 16.6 | 10.3 | 16.5 | 19.9 | 14.9 | 16.1 |
| [mg KOH/g (A)] | | | | | | |
| Tg vinyl polymer phase [° C.] | 105 | 50 | 105 | 50 | 0 | 105 |
| Urea content in the | 0.69 | 0.69 | 0.67 | 0.74 | 0.74 | 2.35 |
| polyurethane [meq/g PU] | | | | | | |
| Solid content [wt %] | 30.9 | 35.7 | 25.5 | 34.8 | 34.8 | 36.2 |
| Mn [kg/mole] | 19.6 | 30.7 | 30.7 | 75.1 | 89.1 | 32.4 |
| Mw [kg/mole] | 236 | 708 | 589 | 1378 | 1806 | 512 |
| pH | 7.6 | 7.3 | 8.1 | 7.9 | 7.8 | 7.4 |
| PS [nm] | 86 | 103 | 146 | 52 | 84 | 87 |

### Preparation of Formulations

The polyurethane vinyl polymer hybrid dispersions of Examples 1-12 and of Comparative Experiment 1 were formulated as shown in Table 3. The ingredients listed in Table 3 were added into a PE jar and mixed thoroughly using a Dispermill® (OrangeLine, ATP Engineering B.V.).

TABLE 3
Preparation of the UV curable polyurethane-vinyl polymer hybrid resin
formulation (FUA Ex. 1a-FUA Ex. 15a and FUA CEx. 1-FUA CEx. 3)

| | FUA | FUA | FUA | FUA | FUA | FUA | FUA | FUA | FUA |
|---|---|---|---|---|---|---|---|---|---|
| | Ex. 1a | Ex. 2a | Ex. 3a | Ex. 4a | Ex. 5a | Ex. 6a | Ex. 7a | Ex. 8a | Ex. 9a |
| U/A hybrid dispersion | UA | UA | UA | UA | UA | UA | UA | UA | UA |
| | Ex. 1 | Ex. 2 | Ex. 3 | Ex. 4 | Ex. 5 | Ex. 6 | Ex. 7 | Ex. 9 | Ex. 10 |
| Amount dispersion | 69.0 | 68.4 | 68.4 | 75.8 | 65.2 | 66.8 | 65.9 | 66.5 | 93.1 |
| Water | 59 | 60 | 60 | 52 | 63 | 61 | 62 | 62 | 35 |
| DPGDA | 15.8 | 15.8 | 15.8 | 15.8 | 15.8 | 15.8 | 15.8 | 15.8 | 15.8 |
| Particle size of hybrid | 48 | 43 | 56 | 107 | 89 | 65 | 55 | 114 | 141 |
| (A) + diluent (B) [nm] | | | | | | | | | |
| Butylglycol | 1.5 | 1.5 | 1.5 | 1.5 | 1.5 | 1.5 | 1.5 | 1.5 | 1.5 |
| BYK-346 | 0.75 | 0.75 | 0.75 | 0.75 | 0.75 | 0.75 | 0.75 | 0.75 | 0.75 |
| Tego airex 902W | 0.75 | 0.75 | 0.75 | 0.75 | 0.75 | 0.75 | 0.75 | 0.75 | 0.75 |
| Borchi Gel L75N:water | 1.5 | 1.5 | 1.5 | 1.5 | 1.5 | 1.5 | 1.5 | 1.5 | 1.5 |
| 1:1 | | | | | | | | | |
| Omnirad 500 | 1.5 | 1.5 | 1.5 | 1.5 | 1.5 | 1.5 | 1.5 | 1.5 | 1.5 |
| Ratio (A):(B) | 60:40 | 60:40 | 60:40 | 60:40 | 60:40 | 60:40 | 60:40 | 60:40 | 60:40 |
| C═C meq/g solids | 3.31 | 3.31 | 3.31 | 3.31 | 3.31 | 3.31 | 3.31 | 3.31 | 3.31 |
| (A) + (B) | | | | | | | | | |

| | FUA | FUA | FUA | FUA | FUA | FUA | FUA | FUA | FUA |
|---|---|---|---|---|---|---|---|---|---|
| | Ex. 10a | Ex. 11a | Ex. 12a | Ex13a | Ex. 14a | Ex. 15a | CEx. 1 | CEx. 2 | CEx. 3 |
| U/A hybrid | UA | UA | UA | UA | UA | UA | UA | UA | UA |
| dispersion | Ex. 3 | Ex. 11 | Ex. 12 | Ex. 3 | Ex. 11 | Ex. 8 | CEx1 | Ex1 | Ex1 |
| Amount | 68.4 | 68.2 | 79.6 | 68.4 | 90.9 | 76.8 | 65.5 | 69.0 | 69.0 |
| dispersion | | | | | | | | | |
| Water | 60 | 60 | 53 | 60 | 39 | 51 | 63 | 59 | 59 |
| DPGDA | | 10.6 | 11.9 | | 7.9 | 7.9 | 15.8 | | |
| GPTA | 15.8 | | | | | 7.9 | | | |
| DiTMPTA | | 5.2 | | | | | | | |
| EO-PETiA | | | | 15.8 | | | | | |
| EGDMA | | | | | | | | 15.8 | |
| DPHA | | | | | | | | | 15.8 |
| Particle size of | 52 | 48 | 110 | 53 | 74 | 95 | | | |
| hybrid (A) + | | | | | | | | | |
| diluent (B) [nm] | | | | | | | | | |
| Texanol | | | | | 5.6 | | | | |
| Butylglycol | 1.5 | 1.5 | 1.5 | 1.5 | 1.5 | 1.5 | 1.5 | 1.5 | 1.5 |
| BYK-346 | 0.75 | 0.75 | 0.75 | 0.75 | 0.75 | 0.75 | 0.75 | 0.75 | 0.75 |
| Tego airex 902W | 0.75 | 0.75 | 0.75 | 0.75 | 0.75 | 0.75 | 0.75 | 0.75 | 0.75 |
| Borchi Gel | 1.5 | 1.5 | 1.5 | 1.5 | 1.5 | 1.5 | 1.5 | 1.5 | 1.5 |
| L75N:water 1:1 | | | | | | | | | |
| Omnirad 500 | 1.5 | 1.5 | 1.5 | 1.5 | 1.5 | 1.5 | 1.5 | 1.5 | 1.5 |
| Ratio (A):(B) | 60:40 | 60:40 | 70:30 | 60:40 | 80:20 | 60:40 | 60:40 | 60:40 | 60:40 |
| C═C meq/g solids | 2.80 | 3.31 | 2.48 | 2.80 | 1.65 | 3.05 | 3.31 | 4.04 | 4.15 |
| (A) + (B) | | | | | | | | (methacylate) | |

For the matted formulation FUA Ex1b-15b respectively, 1.8 g of Acematt TS-100 was added to 100 grams of formulation FUA Ex. 1-15 respectively, see Table 4.

TABLE 4
Formulations FUA 1b-FUA15b with matting agent

| | Matted formulation FUA Ex. 1b-15b | |
|---|---|---|
| Formulation FUA Ex. 1a-15a | 100 | g |
| Acematt TS-100 | 1.8 | g |

### Application of Formulations

The so-obtained coating compositions were applied on a Leneta card (2C Leneta Inc) using a 125 μm wire rod applicator. The coated cards were dried for 10 minutes in an oven with airspeed of 1.2 m/s at 50° C. Subsequently the so-obtained dried composition was cured, the cure conditions are indicated in Tables 5-7. In Table 8 resp. a 125, 75, 50 and 25 μm wire rod applicator were used.

### Curing of the Dried Coating Composition

### Excimer/UV Cure:

Immediately (within 20 seconds) after drying the formulations were cured on a UVio curing rig with a conveyor belt speed of 15 m/min equipped with 2 lamps. The first Lamp was an Excirad 172 lamp (IOT GmbH, xenon based excimer lamp generating 172 nm light) under which the cure was performed with a radiation dose of 11.4 mJ/cm² (determined with an ExciTrack172, IOT GmbH) in a nitrogen atmosphere (02 level <50 ppm detected with IOT inline detector). The next cure step was performed by the second lamp being a Light Hammer 10 Mark III equipped with a H-bulb operating @50% power (Heraeus Holding, Hg doped UV lamp generating UV light with wave lengths ≥315 nm, 181 mJ/cm² total dose as determined with an Power Puck II (EIT Inc)).

### Conventional UV Cure Atmospheric (Conv UV Cure Atmosph):

Immediately (within 20 seconds) after drying the formulations were cured on a UVio curing rig with a conveyor belt speed of 15 m/min. The cure step was performed by a Light Hammer 10 Mark III equipped with a H-bulb operating @50% power (Heraeus Holding, Hg doped UV lamp generating UV light with wave lengths ≥315 nm, 181 mJ/cm² total dose as determined with an Power Puck II (EIT Inc)) in air.

### Conventional UV Cure Inert (Conv UV Cure Inert):

Immediately (within 20 seconds) after drying the formulations were cured on a UVio curing rig with a conveyor belt speed of 15 m/min. The cure step was performed by a Light Hammer 10 Mark III equipped with a H-bulb operating @50% power (Heraeus Holding, Hg doped UV lamp generating UV light with wave lengths ≥315 nm, 181 m·J/cm² total dose as determined with an Power Puck II (EIT Inc)) under inert atmosphere.

### Testing of the Cured Coatings

The gloss and the coffee, red wine and mustard resistances of the cured coatings were determined as described above. The measured gloss values are reported in Table 5 and 7. The coffee, red wine and mustard resistances are reported in Tables 5 and 6.

TABLE 5
Gloss values measured of the formulation not containing matting agent and cured
with Excimer/UV cure; gloss values of the formulation containing matting agent
and cured with the conventional UV cure process under atmospheric conditions;
stain resistances measured colorimetric of the formulation not containing matting
agent and cured with Excimer/UV cure and stain resistances measured colorimetric
of the formulation containing matting agent and cured with the conventional
UV cure process under atmospheric conditions (Conv UV atmosph) resp. cured with
the conventional UV cure process under inert conditions (Conv UV inert)

| | | | | | | | Comparative | |
|---|---|---|---|---|---|---|---|---|
| | | | | | | | Experiments | |
| | Examples | | | | | | Formulation with | |
| | Formulation without matting | | | Comparative Experiments | | | matting agent | |
| | agent (formulations FUA Ex. | | | Formulation with matting agent | | | (formulations FUA | |
| | 1a-15a) | | | (formulations 1b-15b) | | | Ex. 1b-15b) | |
| | Excimer/UV cure | | | Conv UV Atmosp | | | Conv UV Inert | |
| | Gloss | Δb | Δa Red | Gloss | Δb | Δa Red | Δb | Δa Red |
| | (GU20°/ | Coffee | Wine | (GU20°/ | Coffee | Wine | Coffee | Wine |
| | GU60°) | 6 hrs | 6 hrs | GU60°) | 6 hrs | 6 hrs | 6 hrs | 6 hrs |
| FUA Ex. 1 | 0.2/1.8 | 5.3 | −0.2 | 0.4/4.2 | 12.6 | 10.0 | 12.0 | 6.5 |
| FUA Ex. 2 | 0.2/1.7 | 5.6 | −0.2 | 0.5/5.7 | 17.2 | 8.3 | 14.8 | 8.2 |
| FUA Ex. 3 | 0.1/1.3 | 5.0 | −0.2 | 0.8/8.5 | 20.6 | 10.7 | 15.6 | 9.2 |
| FUA Ex. 4 | 0.1/1.5 | 4.0 | −0.2 | 0.4/4.4 | 14.4 | 8.5 | 10.8 | 4.7 |
| FUA Ex. 5 | 0.2/1.5 | 5.0 | −0.2 | 1.6/13.5 | 18.7 | 18 | 16.45 | 15.8 |
| FUA Ex. 6 | 0.2/1.7 | 5.7 | −0.5 | 0.5/5.4 | 18.8 | 8.5 | 16.3 | 6.8 |
| FUA Ex. 7 | 0.2/2 | 6.8 | −0.3 | 0.5/5.5 | 19.9 | 12.3 | 18.0 | 11.0 |
| FUA Ex. 8 | 0.2/2.3 | 1.9 | −0.1 | 0.5/5.6 | 8 | 1.9 | 5.7 | 1.0 |
| FUA Ex. 9 | 0.2/3 | 2.5 | −0.3 | 0.5/5.5 | 13.2 | 7.7 | 13.0 | 3.3 |
| FUA Ex. 10 | 0.4/5 | 9.6 | 1.9 | 0.5/4.9 | 16.5 | 9.9 | 14.3 | 7.1 |
| FUA Ex. 11 | 0.2/1.9 | 2.5 | 0.1 | 1.9/14.7 | 15.7 | 8.1 | 12.7 | 3.7 |
| FUA Ex. 12 | 0.1/1.2 | 4.6 | −0.2 | 0.6/6.7 | 16.2 | 9.1 | 14.6 | 4.8 |
| FUA Ex. 13 | 0.5/5.1 | 15.6 | 0.9 | 0.3/4.1 | 18.4 | 9.8 | 17.4 | 4.3 |
| FUA Ex. 14 | 0.3/2.3 | 10.5 | 0.7 | 1.1/10.3 | 20.7 | 5.7 | 18.6 | 4.4 |
| FUA Ex. 15 | 0.5/5.5 | 2.6 | −0.3 | 0.4/4.9 | 10.2 | 2.6 | 8.2 | 1.9 |

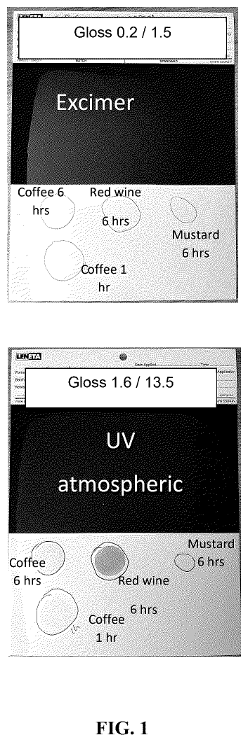

FIG. 1 shows the coated testcard obtained by the Excimer/UV curing process according to the process of the invention of the formulation 5a containing the polyurethane vinyl polymer hybrid dispersion of Example 5 without matting agent (upper testcard) and the coated testcard obtained by conventional UV curing under atmospheric conditions of the formulation 5b containing the polyurethane vinyl polymer hybrid dispersion of Example 5 with matting agent (bottom testcard);
from left to right: Coffee [6 hrs], Red Wine [6 hrs], Mustard [6 hrs] and Coffee [1 hr] stains.

TABLE 6
Stain resistances measured colorimetric (Δb for coffee
and mustard and Δa for red wine) of the formulation
without matting agent and cured with Excimer/UV cure.

| Formulation | Δb Coffee | Δb Coffee | Δa Red Wine | Δb Mustard |
|---|---|---|---|---|
| without | 1 hr | 6 hrs | 6 hrs | 6 hrs |
| matting | Excimer/ | Excimer/ | Excimer/ | Excimer/ |
| agent | UV cure | UV cure | UV cure | UV cure |
| FUA Ex. 1a | 1.9 | 5.3 | −0.2 | 6.8 |
| FUA Ex. 2a | 2.8 | 5.6 | −0.2 | 6.3 |
| FUA Ex. 3a | 0.9 | 5.0 | −0.2 | 6.5 |
| FUA Ex. 4a | −0.1 | 4.0 | −0.2 | 6.6 |
| FUA Ex. 5a | 1.7 | 5.0 | −0.2 | 9.5 |
| FUA Ex. 6a | 3.3 | 5.7 | −0.5 | 10.6 |
| FUA Ex. 7a | 1.6 | 6.8 | −0.3 | 4.8 |
| FUA Ex. 8a | 0.5 | 1.9 | −0.1 | 3.1 |
| FUA Ex. 9a | 0.4 | 2.5 | −0.3 | 2.4 |
| FUA Ex. 10a | 2.1 | 9.6 | 1.9 | 11.4 |
| FUA Ex. 11a | −0.03 | 2.5 | 0.1 | 5.6 |
| FUA Ex. 12a | 1.9 | 4.6 | −0.2 | 9.9 |
| FUA Ex. 13a | 7.8 | 15.6 | 0.9 | 16.6 |
| FUA Ex. 14a | 6 | 10.5 | 0.7 | 15.8 |
| FUA Ex. 15a | 1.2 | 2.6 | −0.3 | 7.0 |

TABLE 7
Gloss values measured after combined excimer/UV cure
and conventional UV cure under atmospheric conditions
of the formulation without matting agent.

| | |
|---|---|
| | Conventional UV Cure |
| Excimer/UV cure | atmospheric |

| | GU 20° | GU 60° | GU 20° | GU 60° |
|---|---|---|---|---|
| FUA Ex. 1a | 0.2 | 1.8 | 68 | 86 |
| FUA Ex. 2a | 0.2 | 1.7 | 62 | 86 |
| FUA Ex. 3a | 0.1 | 1.3 | 66 | 86 |
| FUA Ex. 4a | 0.1 | 1.5 | 61 | 84 |
| FUA Ex. 5a | 0.2 | 1.5 | 62 | 85 |
| FUA Ex. 6a | 0.2 | 1.7 | 65 | 85 |
| FUA Ex. 7a | 0.2 | 2 | 54 | 82 |
| FUA Ex. 8a | 0.2 | 2.3 | 60 | 85 |
| FUA Ex. 9a | 0.2 | 3 | 48 | 80 |
| FUA Ex. 10a | 0.4 | 5 | 65 | 85 |
| FUA Ex. 11a | 0.2 | 1.9 | 50 | 86 |
| FUA Ex. 12a | 0.1 | 1.2 | 66 | 89 |
| FUA Ex. 13a | 0.5 | 5.1 | 70 | 86 |
| FUA Ex. 14a | 0.3 | 2.3 | 67 | 89 |
| FUA Ex. 15a | 0.5 | 5.5 | 61 | 85 |
| FUA CEx. 1a | 50.9 | 79.9 | 50 | 81 |
| FUA CEX. 2a | 66 | 85 | 60 | 83 |
| FUA CEX. 3a | 53.5 | 78.5 | 36 | 58 |

TABLE 8
Effect of layer thickness on gloss values

| | Layer thickness wet | Dry Film | |
|---|---|---|---|
| | film thickness | thickness | Gloss Unites |
| Formulation | [μm] | [μm] | [20°/60°/85°] |
| FUA Ex. 4a | 125 | 35 | 0.1/1.5/41 |
| FUA Ex. 4a | 75 | 21 | 0.2/1.6/41 |
| FUA Ex. 4a | 50 | 14 | 0.2/1.5/40 |
| FUA Ex. 4a | 25 | 7 | 0.2/1.7/42 |
| FUA Ex. 4a | 16 | 4 | 0.2/2.7/53 |
| FUA Ex. 4a | 125 - conventional | 35 | 61/84/97 |
| | UV cure | | |
| FUA Ex. 4b | 16 - matting agent, | 4 | No decent film |
| | conventional UV | | obtained |
| | cure | | |

With the process of the invention, low gloss coatings can be obtained with a very low dry thickness, even low gloss coatings with a dry thickness of 4 micron could be obtained, while when the formulation contains matting agent (formulation FUA Ex. 4b) and the formulation was cured with conventional UV curing, a decent film with such a low dry thickness could not be obtained.

### Comparative Experiments 4-10

A representative group of commercially available waterborne UV curable coating dispersions, as specified in Table 9, were applied on a Leneta card (2C Leneta Inc) using a 125 μm wire rod applicator. The coated cards were dried for 10 minutes in an oven with airspeed of 1.2 m/s at 50° C. Subsequently the so-obtained dried composition was cured using Conventional UV cure atmospheric and Excimer/UV cure as described above. The measured gloss values are reported in Table 9. The commercially available waterborne UV curable coating compositions as indicated in Table 9 have a different composition than the aqueous, radiation-curable coating composition of the present invention.

TABLE 9
Gloss values measured after conventional UV cure under atmospheric
conditions and combined Excimer/UV cure of a representative group
of commercially available waterborne UV curable coating compositions

| | Conventional UV Cure | | | | | |
|---|---|---|---|---|---|---|
| | atmospheric | | | Excimer/UV cure | | |
| | GU 20° | GU 60° | GU 85° | GU 20° | GU 60° | GU 85° |
| NeoRad ™ UV14 | 70 | 89 | 97 | 72 | 90 | 97 |
| NeoRad ™ R-520 | 78 | 93 | 99 | 80 | 93 | 99 |
| NeoRad ™ R-540 | 66 | 90 | 96 | 70 | 90 | 96 |
| Decovery ® SP-7100 | 71 | 92 | 98 | 65 | 91 | 97 |
| Bayhydrol ® UV 2280 | 82 | 95 | 99 | 81 | 94 | 99 |
| Bayhydrol ® UV 2282 | 29 | 64 | 69 | 30 | 66 | 72 |
| Bayhydrol ® eco UV 2877 | 69 | 91 | 98 | 72 | 92 | 97 |

Table 9 illustrates that the representative group of commercially available, waterborne UV curable dispersions, when subjected to Excimer/UV cure, do not result in matt coatings.

1. A process for producing a coating from an aqueous, radiation-curable coating composition, wherein the process comprises the steps in the sequence (1) to (4):
(1) applying an aqueous, radiation-curable coating composition on a surface of a substrate,
(2) drying the aqueous, radiation-curable coating composition, affording an at least partially dried coating composition,
(3) irradiating the at least partially dried coating composition with UV light having a wavelength ≤220 nm under inert atmosphere, followed by
(4) irradiating with UV light having a wavelength ≥300 nm or with E-beam, wherein the aqueous, radiation-curable coating composition is a dispersion comprising:
(A) at least one hybrid (A) of at least one polyurethane and at least one vinyl polymer, wherein
the hybrid (A) is obtained by free-radical polymerization of at least one vinyl monomer in the presence of at least one water-dispersed polyurethane,
the hybrid (A) is essentially free of radiation-curable, ethylenically unsaturated bonds,
the polyurethane of the hybrid (A) has a urea group (—NH—CO—NH—) concentration of at least 0.1 milli-equivalents per g of polyurethane and of at most 1.9 milli-equivalents per g of polyurethane, and
the polyurethane and the vinyl polymer of the hybrid (A) are present in a weight ratio of polyurethane and vinyl polymer ranging from 25:75 to 95:5,
(B) at least one radiation-curable diluent (B) with a molar mass less than 750 g/mol and with an acrylate functionality of from 2 to 5, and
(C) water and optionally organic solvent, whereby the optional organic solvent is present in an amount of at most 30 wt. %, based on the total amount of water and organic solvent,
wherein
the amount of (A) is from 30 to 85 wt. % and the amount of (B) is from 15 to 70 wt. %, based on the total amount of (A) and (B).

2. The process according to claim 1, wherein the polyurethane of the hybrid (A) has a urea group content of at most 1.7 meq per g of polyurethane and of at least 0.2 meq per g of polyurethane.

3. The process according to claim 1, wherein the polyurethane and the vinyl polymer are present in the polyurethane-vinyl polymer hybrid (A) in a weight ratio of polyurethane and vinyl polymer ranging from 30:70 to 90:10.

4. The process according to claim 1,
wherein the polyurethane-vinyl polymer hybrid (A) has an acid value of 3 to 45 mg KOH/g of the hybrid (A), and
wherein the polyurethane of the polyurethane-vinyl polymer hybrid (A) has an acid value of from 5 to 50, and
wherein the vinyl polymer of the hybrid (A) has an acid value of from 0 to 10 mg KOH/g solids of vinyl polymer.

5. The process of claim 1, wherein the acrylate functionality of the at least one radiation-curable diluent (B) is from 2 to 4.

6. The process according to claim 1, wherein at least 70 wt. % of the radiation-curable diluents (B) is selected from the group consisting of: di(trimethylolpropane) tetra-acrylate (di-TMPTA) with the corresponding molecular formula C₂₄H₃₄O₉ and its corresponding molar mass of 467 g/mol, di(trimethylolpropane) tetra-acrylate comprising alkoxy groups, di(trimethylolpropane) tri-acrylate (di-TMP3A) with the corresponding molecular formula C₂₁H₃₂O₈ and its corresponding molar mass of 412 g/mol, di(trimethylolpropane) tri-acrylate comprising alkoxy groups, glyceryl propoxy triacrylate (GPTA) with the corresponding molecular formula C₂₁H₃₂O₉ and its corresponding molar mass of 428 g/mol, glyceryl propoxy triacrylate comprising additional alkoxy groups, pentaerythritol tetra-acrylate (PET4A) with the corresponding molecular formula C₁₇H₂₀O₈ and its corresponding molar mass of 352 g/mol, pentaerythritol tetra-acrylate comprising alkoxy groups, pentaerythritol tri-acrylate (PET3A) with the corresponding molecular formula C₁₄H₁₈O₇ and its corresponding molar mass of 298 g/mol, pentaerythritol tri-acrylate comprising alkoxy groups, trimethylolpropane triacrylate (TMPTA) with the corresponding molecular formula C₁₅H₂₀O₆ and its corresponding molar mass of 296 g/mol, trimethylolpropane triacrylate comprising alkoxy groups, dipropyleneglycol diacrylate (DPGDA) with the corresponding molecular formula C₁₂H₁₈O₅ and its corresponding molar mass of 242 g/mol, dipropyleneglycol diacrylate comprising additional alkoxy groups, and any mixture thereof.

7. The process of claim 1,
wherein the amount of (A) is from 40 to 80 wt. % and the amount of (B) is from 20 to 60 wt. %, based on the total amount of (A) and (B), and
wherein the amount of water in the aqueous, radiation-curable coating composition is at least 30 wt. %, based on the entire weight of the aqueous, radiation-curable coating composition, and
wherein the optional organic solvent is present in an amount of at most 3 wt. %, where the amount of organic solvent is given based on the total amount of water and organic solvent present in the aqueous, radiation-curable coating composition.

8. The process of claim 1, wherein the polyurethane is the reaction product of at least the following components:
(A1) at least one polyisocyanate,
(A2) at least one isocyanate-reactive compound that contains at least one salt group which is capable to render the polyurethane dispersible in water and/or at least one functional group that can be converted into a salt group which is capable to render the polyurethane dispersible in water,
(A3) optionally at least one isocyanate-reactive compound containing at least one non-ionic group which is capable to render the polyurethane dispersible in water,
(A4) at least one isocyanate-reactive polyol other than (A2) and (A3) having an OH number of from 25 to 225 mg KOH/g solids,
(A5) optionally at least one isocyanate-reactive polyol other than (A2) and (A3) having an OH number higher than 225 mg KOH/g solids and lower than 1850 mg KOH/g solids, and
(A6) water or at least one nitrogen containing chain extender compound;
wherein the isocyanate-reactive polyol(s) (A4) has an OH number of from 35 to 190 mg KOH/g solids and the polyurethane comprises the isocyanate-reactive polyols (A4) in an amount of from 20 to 80 wt. %, based on the weight of the polyurethane; and
wherein the polyurethane comprises at least one nitrogen containing chain extender with a NHₓ (wherein x is 1 or 2) functionality of 2 or 3.

9. The process of claim 1,
wherein the hybrid (A) has a radiation-curable, ethylenically unsaturated bond concentration of less than 0.20 milli-equivalents (meq) per g of hybrid (A), where the radiation-curable, ethylenically unsaturated bond concentration is determined with the method as described in the description, and
wherein (A) and (B) together have a radiation-curable, ethylenically unsaturated bond concentration of 0.8 to 5.0 milli-equivalents (meq) per g of (A)+(B), where the radiation-curable, ethylenically unsaturated bond concentration is determined with the method as described in the description.

10. The process of claim 1, wherein the z-average particle size of the dispersion consisting of (A), (B) and (C) is from 20 to 1000 nm, where the z-average particle size is determined with the method as described in the description.

11. The process of claim 1, wherein the coating has a dry thickness of at least 2 micron and of at most 100 micron.

12. The process of claim 1, wherein the irradiating in step (3) is effected by excimer UV lamps with UV light having a wavelength ≥120 nm.

13. The process of claim 1, wherein UV irradiation is applied in step (4) and the aqueous, radiation-curable coating composition comprises one or more photo-initiators.

14. (canceled)

15. A coated substrate, wherein the substrate is coated according to the process of claim 1.

16. The process according to claim 1, wherein the polyurethane of the hybrid (A) has a urea group content of at most 0.9 meq per g of polyurethane and of at least 0.35 meq per g of polyurethane.

17. The process according to claim 1, wherein the polyurethane and the vinyl polymer are present in the polyurethane-vinyl polymer hybrid (A) in a weight ratio of polyurethane and vinyl polymer ranging from 65:35 to 80:20.

18. The process according to claim 1,
wherein the polyurethane-vinyl polymer hybrid (A) has an acid value of from 5 to 35 mg KOH/g of the hybrid (A), and
wherein the polyurethane of the polyurethane-vinyl polymer hybrid (A) has an acid value of from 10 to 40, and
wherein the vinyl polymer of the hybrid (A) has an acid value of less than 8 mg KOH/g solids of vinyl polymer.

19. The process according to claim 1,
wherein the polyurethane-vinyl polymer hybrid (A) has an acid value of from 6 to 28 mg KOH/g of the hybrid (A), and
wherein the polyurethane of the polyurethane-vinyl polymer hybrid (A) has an acid value of from 15 to 30 mg KOH/g solids of the polyurethane, and
wherein the vinyl polymer of the hybrid (A) has an acid value of less than 5 mg KOH/g solids of vinyl polymer.

20. The process of claim 1, wherein the vinyl polymer of the hybrid (A) has a glass transition temperature T_{g} of from −5° C. to 115° C.

21. The process of claim 1, wherein at least 90 wt. % of the radiation-curable diluents (B) is selected from the group consisting of:
di(trimethylolpropane) tetra-acrylate (di-TMPTA) with the corresponding molecular formula C₂₄H₃₄O₉ and its corresponding molar mass of 467 g/mol,
di(trimethylolpropane) tetra-acrylate comprising alkoxy groups,
di(trimethylolpropane) tri-acrylate (di-TMP3A) with the corresponding molecular formula C₂₁H₃₂O₈ and its corresponding molar mass of 412 g/mol,
di(trimethylolpropane) tri-acrylate comprising alkoxy groups,
glyceryl propoxy triacrylate (GPTA) with the corresponding molecular formula C₂₁H₃₂O₉ and its corresponding molar mass of 428 g/mol,
glyceryl propoxy triacrylate comprising additional alkoxy groups,
pentaerythritol tetra-acrylate (PET4A) with the corresponding molecular formula C₁₇H₂₀O₈ and its corresponding molar mass of 352 g/mol,
pentaerythritol tetra-acrylate comprising alkoxy groups,
pentaerythritol tri-acrylate (PET3A) with the corresponding molecular formula C₁₄H₁₈O₇ and its corresponding molar mass of 298 g/mol,
pentaerythritol tri-acrylate comprising alkoxy groups, trimethylolpropane triacrylate (TMPTA) with the corresponding molecular formula C₁₅H₂₀O₆ and its corresponding molar mass of 296 g/mol, trimethylolpropane triacrylate comprising alkoxy groups,
dipropyleneglycol diacrylate (DPGDA) with the corresponding molecular formula C₁₂H₁₈O₅ and its corresponding molar mass of 242 g/mol,
dipropyleneglycol diacrylate comprising additional alkoxy groups,
and any mixture thereof.
